(19) United States
(12) Patent Application Publication
(10) Pub. No.: US 2023/0122908 A1
(43) Pub. Date: Apr. 20, 2023

(54) INTERLEAVING TECHNIQUES FOR WIRELESS COMMUNICATIONS SYSTEMS

(71) Applicant: QUALCOMM Incorporated, San Diego, CA (US)

(72) Inventors: Qiaoyu LI, Beijing (CN); Chao WEI, Beijing (CN); Alexandros MANOLAKOS, Escondido, CA (US)

(21) Appl. No.: 17/759,611

(22) PCT Filed: Feb. 26, 2020
(86) PCT No.: PCT/CN2020/076778

§ 371 Date: Jul. 27, 2022

(51) Int. Cl. H04L 1/00; H04W 72/0446; H04L 1/08

(52) U.S. Cl. CPC H04L 1/0071; H04L 1/0041; H04W 72/0446; H04L 1/08

(57) ABSTRACT

Methods, systems, and devices for wireless communications are described. A wireless device, such as a base station or a user equipment (UE), may identify one or more parameters associated with an interleaving pattern. The one or more parameters associated with the interleaving pattern may include at least one different interleaving parameter for different slots, one or more cyclic shifts of the interleaving pattern for one or more slots, or both. The wireless device may communicate one or more repetitions of data in accordance with the one or more parameters associated with the interleaving pattern. Additionally or alternatively, the wireless device may identify a type of an uplink payload for an uplink transmission. The wireless device may identify an interleaving pattern based on the type of the uplink payload. The wireless device may transmit the uplink transmission in accordance with the identified interleaving pattern.

### CROSS REFERENCE

The present Application is a 371 national stage filing of International PCT Application No. PCT/CN2020/076778 by LI et al. entitled “INTERLEAVING TECHNIQUES FOR WIRELESS COMMUNICATIONS SYSTEMS,” filed Feb. 26, 2020, which is assigned to the assignee hereof, and which is expressly incorporated by reference in its entirety herein.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE). In some wireless communications system, devices may transmit or receive relatively low quality communications. For example, transmissions between devices may be subject to interference, such as deep fading. Such interference may result in inefficient or unreliable communications.

### SUMMARY

A method of wireless communications at a UE is described. The method may include identifying an interleaving pattern including a mapping between one or more virtual resource blocks (VRBs) and one or more physical resource blocks (PRBs) corresponding to a set of slots, the interleaving pattern including one or more parameters for at least a first slot corresponding to a repetition of data, performing an interleaving process based on the one or more parameters of the interleaving pattern, the one or more parameters including at least one different interleaving parameter for different slots, one or more cyclic shifts of the interleaving pattern for one or more slots, or both, and communicating, with a base station, the repetition of the data over the one or more slots based on the interleaving process.

An apparatus for wireless communications at a UE is described. The apparatus may include a processor, memory coupled with the processor, and instructions stored in the memory. The instructions may be executable by the processor to cause the apparatus to identify an interleaving pattern including a mapping between one or more VRBs and one or more PRBs corresponding to a set of slots, the interleaving pattern including one or more parameters for at least a first slot corresponding to a repetition of data, perform an interleaving process based on the one or more parameters of the interleaving pattern, the one or more parameters including at least one different interleaving parameter for different slots, one or more cyclic shifts of the interleaving pattern for one or more slots, or both, and communicate, with a base station, the repetition of the data over the one or more slots based on the interleaving process.

Another apparatus for wireless communications at a UE is described. The apparatus may include means for identifying an interleaving pattern including a mapping between one or more VRBs and one or more PRBs corresponding to a set of slots, the interleaving pattern including one or more parameters for at least a first slot corresponding to a repetition of data, performing an interleaving process based on the one or more parameters of the interleaving pattern, the one or more parameters including at least one different interleaving parameter for different slots, one or more cyclic shifts of the interleaving pattern for one or more slots, or both, and communicating, with a base station, the repetition of the data over the one or more slots based on the interleaving process.

A non-transitory computer-readable medium storing code for wireless communications at a UE is described. The code may include instructions executable by a processor to identify an interleaving pattern including a mapping between one or more VRBs and one or more PRBs corresponding to a set of slots, the interleaving pattern including one or more parameters for at least a first slot corresponding to a repetition of data, perform an interleaving process based on the one or more parameters of the interleaving pattern, the one or more parameters including at least one different interleaving parameter for different slots, one or more cyclic shifts of the interleaving pattern for one or more slots, or both, and communicate, with a base station, the repetition of the data over the one or more slots based on the interleaving process.

Some examples of the method, apparatuses, and non-transitory computer-readable medium described herein may further include operations, features, means, or instructions for identifying the one or more parameters of the interleaving pattern based on a pre-configuration associated with the interleaving pattern, a configuration received from a base station, or a combination thereof.

Some examples of the method, apparatuses, and non-transitory computer-readable medium described herein may further include operations, features, means, or instructions for receiving an indication from the base station, where identifying the one or more parameters may be based on the indication, and where the indication includes a radio resource control configuration, a medium access control control element indication, a downlink control information indication, or any combination thereof.

Some examples of the method, apparatuses, and non-transitory computer-readable medium described herein may further include operations, features, means, or instructions for receiving a communication from the base station, and identifying the pre-configuration associated with the interleaving pattern based on the received communication, where identifying the one or more parameters may be based on the pre-configuration.

In some examples of the method, apparatuses, and non-transitory computer-readable medium described herein, identifying the one or more parameters of the interleaving pattern may include operations, features, means, or instructions for identifying the one or more parameters of the interleaving pattern for at least the first slot based on a slot index of the first slot, a total number of slots corresponding to the repetition of the data, or both.

Some examples of the method, apparatuses, and non-transitory computer-readable medium described herein may further include operations, features, means, or instructions for identifying the mapping between the one or more VRBs and the one or more PRBs corresponding to the set of slots, and adjusting the mapping for the first slot based on a cyclic shift for the first slot of the one or more cyclic shifts, where the interleaving pattern includes the adjusted mapping for the first slot.

Some examples of the method, apparatuses, and non-transitory computer-readable medium described herein may further include operations, features, means, or instructions for adjusting the mapping for a second slot of the set of slots based on a cyclic shift for the second slot of the one or more cyclic shifts, where the interleaving pattern includes the adjusted mapping for the second slot.

In some examples of the method, apparatuses, and non-transitory computer-readable medium described herein, adjusting the mapping for the first slot based on the cyclic shift for the first slot may include operations, features, means, or instructions for adjusting a correspondence for a first VRB bundle from a first portion of the one or more PRBs to a second portion of the one or more PRBs in accordance with the cyclic shift for the first slot, where the cyclic shift for the first slot indicates a quantity of VRB bundles between the first portion of the one or more PRBs and the second portion of the one or more PRBs.

Some examples of the method, apparatuses, and non-transitory computer-readable medium described herein may further include operations, features, means, or instructions for generating a first grouping corresponding to the first slot based on a first interleaving parameter of the at least one different interleaving parameter, the first interleaving parameter corresponding to the first slot, and identifying a first mapping between one or more VRBs and one or more PRBs of the interleaving pattern based on the first grouping, where communicating the repetition of the data over the first slot of the one or more slots may be based on the first mapping.

Some examples of the method, apparatuses, and non-transitory computer-readable medium described herein may further include operations, features, means, or instructions for generating a second grouping corresponding to a second slot based on a second interleaving parameter of the at least one different interleaving parameter, the second interleaving parameter corresponding to the second slot, and identifying a second mapping between the one or more VRBs and the one or more PRBs of the interleaving pattern based on the second grouping, where communicating the repetition of the data over a second slot of the one or more slots may be based on the second mapping.

In some examples of the method, apparatuses, and non-transitory computer-readable medium described herein, communicating the repetition of the data over at least the first slot based on the one or more parameters of the interleaving pattern may include operations, features, means, or instructions for transmitting the repetition of the data over an uplink shared channel.

In some examples of the method, apparatuses, and non-transitory computer-readable medium described herein, performing the interleaving process may include operations, features, means, or instructions for interleaving the one or more VRBs and the one or more PRBs in accordance with the one or more parameters, where transmitting the repetition of the data may be based on the interleaving.

In some examples of the method, apparatuses, and non-transitory computer-readable medium described herein, communicating the repetition of the data over at least the first slot based on the one or more parameters of the interleaving pattern may include operations, features, means, or instructions for receiving the repetition of the data over a downlink shared channel.

In some examples of the method, apparatuses, and non-transitory computer-readable medium described herein, performing the interleaving process may include operations, features, means, or instructions for deinterleaving the one or more VRBs and the one or more PRBs in accordance with the one or more parameters based on receiving the repetition of the data.

Some examples of the method, apparatuses, and non-transitory computer-readable medium described herein may further include operations, features, means, or instructions for receiving information from the base station scheduling an uplink transmission from the UE to the base station, and identifying a type of an uplink payload for the uplink transmission, where identifying the one or more parameters of the interleaving pattern may be based on identifying the type of the uplink payload.

In some examples of the method, apparatuses, and non-transitory computer-readable medium described herein, communicating the repetition of the data may include operations, features, means, or instructions for transmitting the uplink transmission based on the interleaving pattern based on the identified type of the uplink payload.

Some examples of the method, apparatuses, and non-transitory computer-readable medium described herein may further include operations, features, means, or instructions for refraining from processing the uplink transmission based on the interleaving pattern based on the identified type of the uplink payload, where communicating the repetition of the data may be based on refraining from processing the uplink transmission.

A method of wireless communications at a UE is described. The method may include receiving information from a base station scheduling an uplink transmission from the UE to the base station, identifying an interleaving pattern for the uplink transmission based on a type of an uplink payload for the uplink transmission, the interleaving pattern including a mapping between one or more VRBs and one or more PRBs, and transmitting the uplink transmission to the base station based on the interleaving pattern.

An apparatus for wireless communications at a UE is described. The apparatus may include a processor, memory coupled with the processor, and instructions stored in the memory. The instructions may be executable by the processor to cause the apparatus to receive information from a base station scheduling an uplink transmission from the UE to the base station, identify an interleaving pattern for the uplink transmission based on a type of an uplink payload for the uplink transmission, the interleaving pattern including a mapping between one or more VRBs and one or more PRBs, and transmit the uplink transmission to the base station based on the interleaving pattern.

Another apparatus for wireless communications at a UE is described. The apparatus may include means for receiving information from a base station scheduling an uplink transmission from the UE to the base station, identifying an interleaving pattern for the uplink transmission based on a type of an uplink payload for the uplink transmission, the interleaving pattern including a mapping between one or more VRBs and one or more PRBs, and transmitting the uplink transmission to the base station based on the interleaving pattern.

A non-transitory computer-readable medium storing code for wireless communications at a UE is described. The code may include instructions executable by a processor to receive information from a base station scheduling an uplink transmission from the UE to the base station, identify an interleaving pattern for the uplink transmission based on a type of an uplink payload for the uplink transmission, the interleaving pattern including a mapping between one or more VRBs and one or more PRBs, and transmit the uplink transmission to the base station based on the interleaving pattern.

Some examples of the method, apparatuses, and non-transitory computer-readable medium described herein may further include operations, features, means, or instructions for identifying the type of the uplink payload for the uplink transmission based on the information from the base station.

In some examples of the method, apparatuses, and non-transitory computer-readable medium described herein, identifying the type of the uplink payload for the uplink transmission may include operations, features, means, or instructions for identifying that the type of the uplink payload in one or more symbols of the uplink transmission includes a higher quantity of the one or more PRBs than a second type of the uplink payload in the one or more symbols of the uplink transmission.

Some examples of the method, apparatuses, and non-transitory computer-readable medium described herein may further include operations, features, means, or instructions for identifying an interleaving parameter associated with the type of the uplink payload based on a quantity of code blocks corresponding to the type of the uplink payload.

Some examples of the method, apparatuses, and non-transitory computer-readable medium described herein may further include operations, features, means, or instructions for identifying the interleaving parameter may be based on receiving a pre-configuration of the interleaving pattern, a radio resource control configuration from the base station, or any combination thereof.

In some examples of the method, apparatuses, and non-transitory computer-readable medium described herein, the type of the uplink payload includes a hybrid automatic repeat request acknowledgment type, a first channel status information type, a second channel status information type, an uplink shared channel data type, or any combination thereof.

Some examples of the method, apparatuses, and non-transitory computer-readable medium described herein may further include operations, features, means, or instructions for receiving second information from the base station scheduling a second uplink transmission from the UE to the base station, identifying a second type of a second uplink payload for the second uplink transmission, and refraining from processing the second uplink transmission based on the interleaving pattern.

In some examples of the method, apparatuses, and non-transitory computer-readable medium described herein, the second type of the second uplink payload includes an uplink control information type.

In some examples of the method, apparatuses, and non-transitory computer-readable medium described herein, identifying the interleaving pattern for the uplink transmission may include operations, features, means, or instructions for identifying one or more parameters of the interleaving pattern for at least a first slot corresponding to a repetition of data based on a pre-configuration, an indication from the base station, or both, where the one or more parameters include at least one different interleaving parameter for different slots, one or more cyclic shifts of the interleaving pattern for one or more slots, or both.

A method of wireless communications at a base station is described. The method may include identifying an interleaving pattern including a mapping between one or more VRBs and one or more PRBs corresponding to a set of slots, the interleaving pattern including one or more parameters at least a first slot corresponding to a repetition of data, performing an interleaving process based on the one or more parameters of the interleaving pattern, the one or more parameters including at least one different interleaving parameter for different slots, one or more cyclic shifts of the interleaving pattern for one or more slots, or both, and communicating, with a UE, the repetition of the one or more slots based on the interleaving process.

An apparatus for wireless communications at a base station is described. The apparatus may include a processor, memory coupled with the processor, and instructions stored in the memory. The instructions may be executable by the processor to cause the apparatus to identify an interleaving pattern including a mapping between one or more VRBs and one or more PRBs corresponding to a set of slots, the interleaving pattern including one or more parameters at least a first slot corresponding to a repetition of data, perform an interleaving process based on the one or more parameters of the interleaving pattern, the one or more parameters including at least one different interleaving parameter for different slots, one or more cyclic shifts of the interleaving pattern for one or more slots, or both, and communicate, with a UE, the repetition of the one or more slots based on the interleaving process.

Another apparatus for wireless communications at a base station is described. The apparatus may include means for identifying an interleaving pattern including a mapping between one or more VRBs and one or more PRBs corresponding to a set of slots, the interleaving pattern including one or more parameters at least a first slot corresponding to a repetition of data, performing an interleaving process based on the one or more parameters of the interleaving pattern, the one or more parameters including at least one different interleaving parameter for different slots, one or more cyclic shifts of the interleaving pattern for one or more slots, or both, and communicating, with a UE, the repetition of the one or more slots based on the interleaving process.

A non-transitory computer-readable medium storing code for wireless communications at a base station is described. The code may include instructions executable by a processor to identify an interleaving pattern including a mapping between one or more VRBs and one or more PRBs corresponding to a set of slots, the interleaving pattern including one or more parameters at least a first slot corresponding to a repetition of data, perform an interleaving process based on the one or more parameters of the interleaving pattern, the one or more parameters including at least one different interleaving parameter for different slots, one or more cyclic shifts of the interleaving pattern for one or more slots, or both, and communicate, with a UE, the repetition of the one or more slots based on the interleaving process.

Some examples of the method, apparatuses, and non-transitory computer-readable medium described herein may further include operations, features, means, or instructions for identifying the one or more parameters of the interleaving pattern based on a pre-configuration associated with the interleaving pattern, an indication of the one or more parameters of the interleaving pattern, or a combination thereof.

Some examples of the method, apparatuses, and non-transitory computer-readable medium described herein may further include operations, features, means, or instructions for receiving, from the UE, the indication of the one or more parameters of the interleaving pattern.

Some examples of the method, apparatuses, and non-transitory computer-readable medium described herein may further include operations, features, means, or instructions for identifying the one or more parameters of the interleaving pattern for at least the first slot may be based on a slot index of the first slot, a total number of slots corresponding to the repetition of the data, or both.

Some examples of the method, apparatuses, and non-transitory computer-readable medium described herein may further include operations, features, means, or instructions for identifying the mapping between the one or more VRBs and the one or more PRBs corresponding to the set of slots, and adjusting the mapping for the first slot based on a cyclic shift for the first slot of the one or more cyclic shifts, where the interleaving pattern includes the adjusted mapping for the first slot.

Some examples of the method, apparatuses, and non-transitory computer-readable medium described herein may further include operations, features, means, or instructions for adjusting the mapping for a second slot of the set of slots based on a cyclic shift for the second slot of the one or more cyclic shifts, where the interleaving pattern includes the adjusted mapping for the second slot.

In some examples of the method, apparatuses, and non-transitory computer-readable medium described herein, adjusting the mapping for the first slot based on the cyclic shift for the first slot may include operations, features, means, or instructions for adjusting a correspondence for a first VRB bundle from a first portion of the one or more PRBs to a second portion of the one or more PRBs in accordance with the cyclic shift for the first slot, where the cyclic shift for the first slot indicates a quantity of VRB bundles between the first portion of the one or more PRBs and the second portion of the one or more PRBs.

Some examples of the method, apparatuses, and non-transitory computer-readable medium described herein may further include operations, features, means, or instructions for generating a first grouping corresponding to the first slot based on a first interleaving parameter of the at least one different interleaving parameter, the first interleaving parameter corresponding to the first slot, and identifying a first mapping between one or more VRBs and one or more PRBs of the interleaving pattern based on the first grouping, where communicating the repetition of the data over the first slot of the one or more slots may be based on the first mapping.

Some examples of the method, apparatuses, and non-transitory computer-readable medium described herein may further include operations, features, means, or instructions for generating a second grouping corresponding to a second slot based on a second interleaving parameter of the at least one different interleaving parameter, the second interleaving parameter corresponding to the second slot, and identifying a second mapping between the one or more VRBs and the one or more PRBs of the interleaving pattern based on the second grouping, where communicating the repetition of the data over a second slot of the one or more slots may be based on the second mapping.

Some examples of the method, apparatuses, and non-transitory computer-readable medium described herein may further include operations, features, means, or instructions for transmitting an indication of the interleaving pattern to the UE, where the indication includes a radio resource control configuration, a medium access control control element indication, a downlink control information indication, or any combination thereof.

In some examples of the method, apparatuses, and non-transitory computer-readable medium described herein, communicating the repetition of the data over at least the first slot based on the one or more parameters of the interleaving pattern may include operations, features, means, or instructions for receiving the repetition of the data over an uplink shared channel.

In some examples of the method, apparatuses, and non-transitory computer-readable medium described herein, performing the interleaving process may include operations, features, means, or instructions for deinterleaving the one or more VRBs and the one or more PRBs in accordance with the one or more parameters based on receiving the repetition of the data.

In some examples of the method, apparatuses, and non-transitory computer-readable medium described herein, communicating the repetition of the data over at least the first slot based on the one or more parameters of the interleaving pattern may include operations, features, means, or instructions for transmitting the repetition of the data over a downlink shared channel.

In some examples of the method, apparatuses, and non-transitory computer-readable medium described herein, performing the interleaving process may include operations, features, means, or instructions for interleaving the one or more VRBs and the one or more PRBs in accordance with the one or more parameters, where transmitting the repetition of the data may be based on the interleaving.

Some examples of the method, apparatuses, and non-transitory computer-readable medium described herein may further include operations, features, means, or instructions for transmitting information to the UE scheduling an uplink transmission from the UE to the base station, and identifying a type of an uplink payload for the uplink transmission, where identifying the one or more parameters of the interleaving pattern may be based on identifying the type of the uplink payload.

In some examples of the method, apparatuses, and non-transitory computer-readable medium described herein, communicating the repetition of the data may include operations, features, means, or instructions for receiving the uplink transmission based on the interleaving pattern based on the identified type of the uplink payload.

Some examples of the method, apparatuses, and non-transitory computer-readable medium described herein may further include operations, features, means, or instructions for refraining from processing the uplink transmission based on the interleaving pattern based on the identified type of the uplink payload, where communicating the repetition of the data may be based on refraining from processing the uplink transmission.

A method of wireless communications at a base station is described. The method may include transmitting information to a UE scheduling an uplink transmission from the UE to the base station, the uplink transmission corresponding to a type of an uplink payload for the uplink transmission, receiving the uplink transmission based on the transmitted information, identifying an interleaving pattern for the uplink transmission based on the type of the uplink payload, the interleaving pattern including a mapping between one or more VRBs and one or more PRBs, and processing the uplink transmission based on the identified interleaving pattern.

An apparatus for wireless communications at a base station is described. The apparatus may include a processor, memory coupled with the processor, and instructions stored in the memory. The instructions may be executable by the processor to cause the apparatus to transmit information to a UE scheduling an uplink transmission from the UE to the base station, the uplink transmission corresponding to a type of an uplink payload for the uplink transmission, receive the uplink transmission based on the transmitted information, identify an interleaving pattern for the uplink transmission based on the type of the uplink payload, the interleaving pattern including a mapping between one or more VRBs and one or more PRBs, and process the uplink transmission based on the identified interleaving pattern.

Another apparatus for wireless communications at a base station is described. The apparatus may include means for transmitting information to a UE scheduling an uplink transmission from the UE to the base station, the uplink transmission corresponding to a type of an uplink payload for the uplink transmission, receiving the uplink transmission based on the transmitted information, identifying an interleaving pattern for the uplink transmission based on the type of the uplink payload, the interleaving pattern including a mapping between one or more VRBs and one or more PRBs, and processing the uplink transmission based on the identified interleaving pattern.

A non-transitory computer-readable medium storing code for wireless communications at a base station is described. The code may include instructions executable by a processor to transmit information to a UE scheduling an uplink transmission from the UE to the base station, the uplink transmission corresponding to a type of an uplink payload for the uplink transmission, receive the uplink transmission based on the transmitted information, identify an interleaving pattern for the uplink transmission based on the type of the uplink payload, the interleaving pattern including a mapping between one or more VRBs and one or more PRBs, and process the uplink transmission based on the identified interleaving pattern.

Some examples of the method, apparatuses, and non-transitory computer-readable medium described herein may further include operations, features, means, or instructions for identifying the type of the uplink payload for the uplink transmission.

In some examples of the method, apparatuses, and non-transitory computer-readable medium described herein, identifying the type of the uplink payload for the uplink transmission may include operations, features, means, or instructions for identifying that the type of the uplink payload in one or more symbols of the uplink transmission includes a higher quantity of the one or more PRBs than a second type of the uplink payload in the one or more symbols of the uplink transmission.

Some examples of the method, apparatuses, and non-transitory computer-readable medium described herein may further include operations, features, means, or instructions for identifying an interleaving parameter associated with the type of the uplink payload based on a quantity of code blocks corresponding to the type of the uplink payload.

Some examples of the method, apparatuses, and non-transitory computer-readable medium described herein may further include operations, features, means, or instructions for identifying the interleaving parameter may be based on receiving a pre-configuration of the interleaving pattern, a radio resource control configuration from the base station, or any combination thereof.

In some examples of the method, apparatuses, and non-transitory computer-readable medium described herein, the type of the uplink payload includes a hybrid automatic repeat request acknowledgment type, a first channel status information type, a second channel status information type, an uplink shared channel data type, or any combination thereof.

Some examples of the method, apparatuses, and non-transitory computer-readable medium described herein may further include operations, features, means, or instructions for transmitting second information to the UE scheduling a second uplink transmission from the UE to the base station, identifying a second type of a second uplink payload for the second uplink transmission, and refraining from processing the second uplink transmission based on the interleaving pattern.

In some examples of the method, apparatuses, and non-transitory computer-readable medium described herein, the second type of the second uplink payload includes an uplink control information type.

In some examples of the method, apparatuses, and non-transitory computer-readable medium described herein, identifying the interleaving pattern for the for the uplink transmission may include operations, features, means, or instructions for identifying one or more parameters of the interleaving pattern for at least a first slot corresponding to a repetition of data based on a pre-configuration, an indication from the base station, or both, where the one or more parameters include at least one different interleaving parameter for different slots, one or more cyclic shifts of the interleaving pattern for one or more slots, or both.

### BRIEF DESCRIPTION OF THE DRAWINGS

FIGS. 1 and 2 illustrate examples of wireless communications systems that support interleaving techniques for wireless communications systems in accordance with aspects of the present disclosure.

FIGS. 3-5 illustrate examples of mapping schemes that support interleaving techniques for wireless communications systems in accordance with aspects of the present disclosure.

FIGS. 6 and 7 show block diagrams of devices that support interleaving techniques for wireless communications systems in accordance with aspects of the present disclosure.

FIG. 8 shows a block diagram of a communications manager that supports interleaving techniques for wireless communications systems in accordance with aspects of the present disclosure.

FIG. 9 shows a diagram of a system including a device that supports interleaving techniques for wireless communications systems in accordance with aspects of the present disclosure.

FIGS. 10 and 11 show block diagrams of devices that support interleaving techniques for wireless communications systems in accordance with aspects of the present disclosure.

FIG. 12 shows a block diagram of a communications manager that supports interleaving techniques for wireless communications systems in accordance with aspects of the present disclosure.

FIG. 13 shows a diagram of a system including a device that supports interleaving techniques for wireless communications systems in accordance with aspects of the present disclosure.

FIGS. 14 through 17 show flowcharts illustrating methods that support interleaving techniques for wireless communications systems in accordance with aspects of the present disclosure.

### DETAILED DESCRIPTION

In some wireless communications systems, wireless devices may employ interleaving to map information from a first group to a second group, such as to map a set of virtual resource blocks (VRBs) to a set of physical resource blocks (PRBs). A PRB may be an example of a resource block on a physical channel (e.g., a quantity of adjacent resource elements (REs) used for communications between devices). A VRB may be an example of a resource block used for user allocations to a corresponding PRB (e.g., a VRB may be the same size as a unit PRB). For example, the VRB may be used to allocate communications (e.g., data communications or control communications) of a VRB for a device to one or more PRBs. Such allocations may enable a device to transmit or receive communications over different PRBs without re-allocating the data of a VRB to a different PRB, which may result in relatively low processing overhead while increasing a frequency diversity of the communications. As an illustrative example, a transmitting device (e.g., a user equipment (UE) or a base station) may generate a VRB by identifying data for allocation to a receiving device and assigning the data across VRBs for resource assignment. The wireless device may transmit the data using PRBs corresponding to the VRBs, for example, in accordance with an interleaving pattern. The receiving wireless device may receive the data using the PRBs and re-construct the data allocated to the VRBs based on deinterleaving the PRBs and the VRBs.

Such interleaving processes may enable a wireless device (e.g., a UE, a base station, etc.) to distribute a code block across frequency ranges based on an interleaving pattern (e.g., the wireless device may map VRB bundles including one or more VRBs to one or more PRBs in accordance with the interleaving pattern). Additionally or alternatively, the wireless device may map multiple code blocks to one or more orthogonal frequency division multiplexing (OFDM) symbols based on an interleaving pattern (e.g., interleaving may be employed within each code block of a set of code blocks). Such interleaving patterns may provide for increased frequency diversity, time diversity, or both, which may result in enhanced reliability of communications. However, in some cases, the wireless device may experience relatively low quality communication conditions. For example, communications in an urban scenario (e.g., an outdoor base station serving one or more indoor UEs) or a rural scenario (e.g., relatively large distances between devices) may result in poor data throughput and communication errors. Additionally or alternatively, the wireless device may have a relatively low quantity of antennas (e.g., the device may be an example of a reduced complexity UE, such as a smart wearable device, an industrial sensor, a video surveillance device, etc. and may have one antenna, two antennas, etc.). In such examples, an interleaved VRB bundle may experience interference (e.g., deep fading) across multiple slots, which may result in inefficient or incomplete communications.

Accordingly, the techniques described herein may provide for enhanced interleaving techniques. For example, the described techniques may enable a wireless device (e.g., a UE or a base station) to identify one or more parameters of an interleaving pattern for one or more slots. In some examples, the wireless device may be pre-configured with the one or more parameters or may receive an indication of the parameters (e.g., a radio resource control (RRC) configuration, a medium access control (MAC) control element (CE) indication, a downlink control information (DCI) indication, etc.), or a combination thereof.

The wireless device may communicate in accordance with the one or more parameters (e.g., the wireless device may receive or send repetitions of data, such as data re-transmissions of a Hybrid automatic repeat request (HARM) procedure, over one or more slots based on the parameters). In some examples, the one or more parameters may include one or more cyclic shifts for one or more slots. For example, a wireless device may shift interleaved VRBs by a value (e.g., a quantity of VRB bundles) of a first cyclic shift for a first slot and a value of a second cyclic shift for a second slot, among other examples as described herein. Additionally or alternatively, the one or more parameters may include at least one interleaving parameter for one or more slots, such as one or more inputs into an interleaving formula, a quantity of rows of an interleaving table, among other examples of parameters as described herein. Thus, the wireless device may map VRBs to PRBs using different parameters for one or more slots, which may result in improved diversity gain and ensure reliable communications.

The described techniques may enable a wireless device to dynamically implement interleaving patterns. For example, a wireless device may identify a type of a communications payload (e.g., a dominant type of uplink payload in each symbol of an uplink transmission from a UE to a base station). The wireless device may communicate based on the identified type. In some examples, the wireless device may implement an interleaving pattern based on the type of the uplink payload. In some other examples, the wireless device may refrain from processing (e.g., interleaving) a transmission based on the type of the uplink payload. In some cases, the wireless device may identify one or more parameters of the interleaving pattern according to the identified type (e.g., a quantity of code blocks, a quantity of rows of an interleaving table, etc.), for example, based on a pre-configuration of the wireless device or an RRC configuration.

Aspects of the disclosure are initially described in the context of wireless communications systems. Aspects of the disclosure are then described in the context of mapping schemes. Aspects of the disclosure are further illustrated by and described with reference to apparatus diagrams, system diagrams, and flowcharts that relate to methods for interleaved mapping.

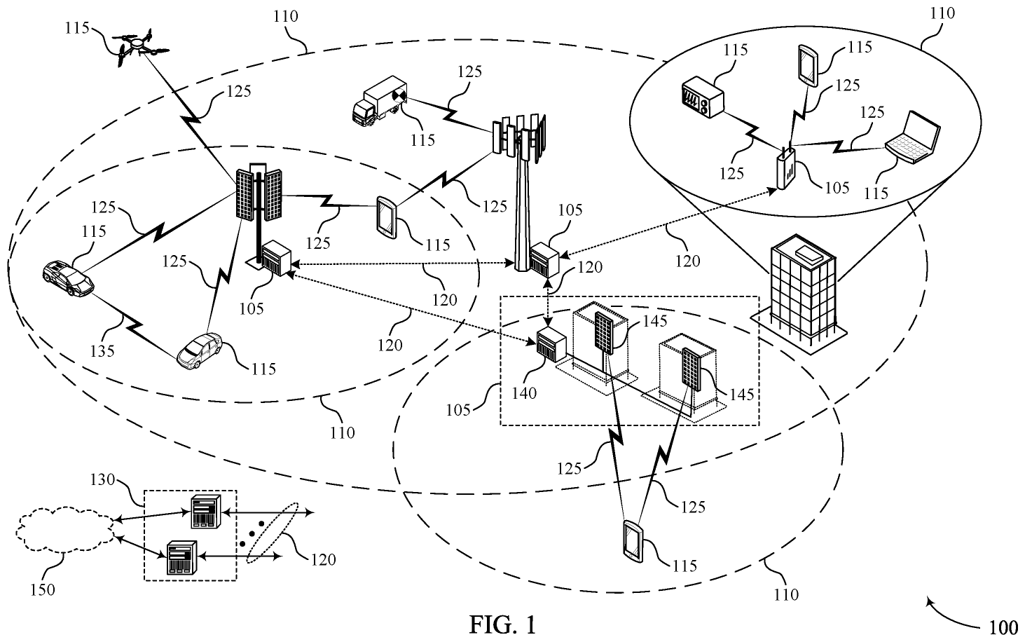

FIG. 1 illustrates an example of a wireless communications system 100 that supports interleaving techniques for wireless communications systems in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Signal waveforms transmitted over a carrier may be made up of multiple subcarriers (e.g., using multi-carrier modulation (MCM) techniques such as OFDM or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The quantity of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame quantity (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the quantity of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a quantity of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a quantity of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to the network operators IP services 150. The network operators IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a quantity of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. HARQ feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In some examples, devices in the wireless communications system 100 (e.g., a UE 115, a base station 105) may employ interleaving to map a set of VRBs to a set of PRBs. For example, a wireless device may distribute a code block across frequency ranges based on an interleaving pattern (e.g., the wireless device may map VRB bundles to one or more PRBs in accordance with the interleaving pattern). Additionally or alternatively, the wireless device may map multiple code blocks to an OFDM symbol based on an interleaving pattern (e.g., interleaving may be employed within each code block of a set of code blocks). Such an interleaving pattern may provide for increased frequency diversity, or time diversity, or both in the wireless communications system 100.

However, in some cases, the wireless communications system 100 may experience relatively poor communication conditions. For example, communications in an urban scenario (e.g., an outdoor base station 105 serving one or more indoor UEs 115) or a rural scenario (e.g., relatively large distances between devices) may result in poor data throughput and communication errors. Additionally or alternatively, the wireless device may be an example of a reduced complexity UE 115, such as a smart wearable device, an industrial sensor, a video surveillance device, etc. In such examples, the UE 115 may have a relatively low quantity of reception antennas, a reduced transmission and reception bandwidth (e.g., 5 MHz to 20 MHz as opposed to a 100 MHz bandwidth, among other examples of bandwidth ranges), reduced computational complexity or memory (e.g., to extend the battery life of the UE 115), etc. Such communication conditions may increase the change of communication errors (e.g., due to interference). For example, a first device may fail to successfully receive data from a second device, and the second device may re-transmit the data over multiple slots (e.g., the second device may implement data re-transmissions to communicate the data). To increase diversity, such re-transmissions may be interleaved in accordance with an interleaving pattern. However, a VRB bundle interleaved to a PRB bundle may experience interference (e.g., deep fading) across multiple slots, which may result in inefficient communications (e.g., communication errors).

The wireless communications system 100 may implement enhanced interleaving techniques to increase diversity gain for communications (e.g., repetitions of data). For example, a wireless device may identify one or more parameters of an interleaving pattern for one or more slots. Such parameters may enable the wireless device to implement different mapping schemes across the one or more slots (e.g., each slot may be associated with a different interleaving pattern, each slot may use a same interleaving pattern that is shifted in accordance with the one or more parameters for each slot, or any combination thereof, among other examples of mapping schemes as described herein). In some examples, the wireless device may be pre-configured with the one or more parameters or may receive an indication of the parameters (e.g., an RRC configuration, a MAC-CE indication, a DCI indication, etc.), or a combination thereof.

The wireless device may communicate in accordance with the one or more parameters (e.g., the wireless device may receive or send data re-transmissions over one or more slots based on the parameters). In some examples, the one or more parameters may include one or more cyclic shifts for one or more slots. For example, a wireless device may shift interleaved VRBs by a value (e.g., a quantity of VRB bundles) for each slot of the one or more slots according to the one or more cyclic shifts corresponding to each slot. Additionally or alternatively, the one or more parameters may include at least one interleaving parameter for one or more slots, such as an indication of a quantity of rows of an interleaving table, among other examples of parameters as described herein. Thus, the wireless device may map VRBs to PRBs using different parameters for one or more slots, which may result in improved diversity gain and ensure reliable communications.

The described techniques may also enable a wireless device to dynamically implement interleaving patterns. For example, a wireless device may identify a type of a communications payload (e.g., a dominant type of uplink payload in each symbol of an uplink transmission from a UE to a base station). The wireless device may communicate based on the identified type. In some examples, the wireless device may implement an interleaving pattern based on the type of the uplink payload. In some other examples, the wireless device may refrain from processing (e.g., interleaving) a transmission based on the type of the uplink payload. In some cases, the wireless device may identify one or more parameters of the interleaving pattern according to the identified type (e.g., a quantity of code blocks, a quantity of rows of an interleaving table, etc.), for example, based on a pre-configuration of the wireless device or an RRC configuration.

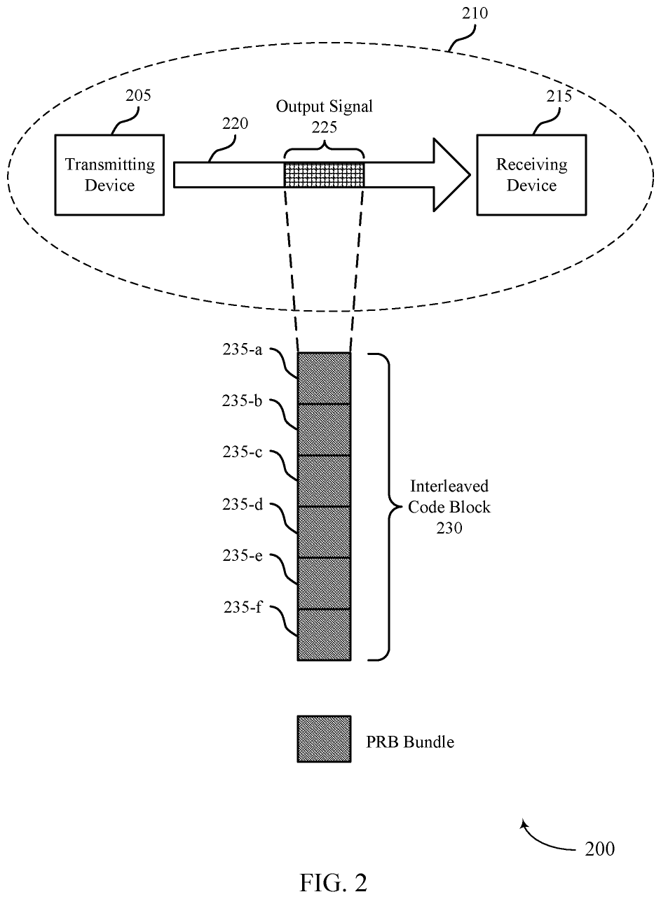

FIG. 2 illustrates an example of a wireless communications system 200 that supports interleaving techniques for wireless communications systems in accordance with aspects of the present disclosure. Wireless communications system 200 may implement aspects of wireless communications system 100. For instance, wireless communications system 200 may include a transmitting device 205 and a receiving device 215, which may each include aspects of base stations 105 or UEs 115 as described with reference to FIG. 1. The wireless communications system 200 may also include a geographic coverage area 210 which may include features described with reference to geographic coverage areas 110 within FIG. 1. In the following description of the wireless communications system 200, the operations performed by the transmitting device 205 and the receiving device 215 may be performed in different orders or at different times, or some operations performed by the transmitting device 205 may be performed by the receiving device, and vice versa.

The transmitting device 205 may transmit an output signal 225 including one or more interleaved code blocks 230 to the receiving device 215. In some examples, the transmitting device 205 may distribute a code block 230 across one or more frequency ranges based on an interleaving pattern (e.g., the transmitting device 205 may map VRBs to PRBs in accordance with the interleaving pattern). Additionally or alternatively, the transmitting device 205 may map one or more (e.g., multiple) code blocks 230 to an OFDM symbol based on an interleaving pattern (e.g., interleaving may be employed within the code block 230).

The transmitting device 205 may identify a set of VRBs to transmit to the receiving device 215. The set of VRBs may contain a quantity of VRB bundles (e.g., one or more VRB bundles), where each VRB bundle may include one or more VRBs (e.g., two VRBs, three VRBs, four VRBs). As an illustrative example, the transmitting device 205 may identify a quantity of VRB bundles, such as six VRB bundles, to transmit to the receiving device 215. In some cases, the transmitting device 205 may identify a quantity of VRB bundles that are allocated for communications between the transmitting device 205 and the receiving device 215. Each VRB bundle may have an associated index indicating a position of the VRB bundle (e.g., with respect to other VRB bundles), or an index for each VRB in the VRB bundle indicating a position of the VRB (e.g., with respect to other VRBs). The set of VRBs may be contiguous or non-contiguous depending on a resource block allocations. For example, in 5G NR, downlink resource allocation in frequency domain Type 1 resource allocations may correspond to a set of contiguous VRB bundles while downlink resource allocation in frequency domain Type 0 resource allocations correspond to non-contiguous VRB bundles.

The transmitting device 205 may map at least some of the set of VRBs to a set of PRBs. As an illustrative example, the transmitting device 205 may map six VRB bundles to six PRB bundles 235, although any quantity of bundles may be used. The transmitting device 205 may map VRB bundles to PRB bundles according to an interleaving pattern (e.g., an interleaving matrix, an interleaving table, an interleaving formula, etc.). As an illustrative example, the transmitting device 205 may map a quantity of VRB bundles (e.g., one or more VRB bundles) to the set of PRB bundles 235 (e.g., one or more PRB bundles 235) according to an interleaving matrix (e.g., an interleaving table, an interleaving grouping). The interleaving matrix may have one or more defined dimensions (e.g., a defined quantity of rows, a defined quantity of columns). The size of the defined dimension of the matrix may correspond to the frequency diversity achieved by mapping VRB bundles to PRB bundles 235 according to the interleaving matrix. Based on a quantity of VRBs (e.g., the quantity of VRB bundles) to be interleaved, the transmitting device 205 may use a different dimension of the interleaving matrix.

For example, if the quantity of rows within the interleaving matrix is defined to be two and the quantity of VRB bundles to be interleaved is eight, the transmitting device 205 may generate an interleaving matrix with two rows and four columns. As another illustrative example, if the quantity of rows within the interleaving matrix is defined to be two and the quantity of VRB bundles to be interleaved is ten, the transmitting device 205 may generate an interleaving matrix with two rows and five columns. In some examples, the interleaving pattern may be an example of an interleaving formula. For example, the interleaving matrices (e.g., interleaving tables) described herein may be implemented as one or more formulas used to map a VRB bundle to a PRB bundle 235.

Thus, the transmitting device 205 may map at least some (e.g., each) of the VRB bundles to one of the PRB bundles 235 to generate the interleaved code block 230. In some cases, the PRB bundles 235 may span an entire bandwidth part. In some other cases, the PRB bundles 235 may span frequency resources allocated for communications between the transmitting device 205 and the receiving device 215, which frequency resources may be a portion (e.g., a subset of frequency resources) of the bandwidth part. The interleaved code block 230 may include a set of interleaved VRB bundles mapped to a set of PRB bundles 235. Additionally or alternatively, the output signal 225 may include more than one interleaved code block 230. Here, the more than one interleaved code blocks 230 may each include sets of VRBs mapped to a set of PRB bundles 235. The transmitting device 205 may transmit the interleaved code block 230 within the output signal 225 to the receiving device 215. In some examples, the transmitting device 205 may additionally transmit an indication of the interleaved code block 230. For example, the transmitting device 205 may transmit information indicating that one or more code blocks 230 are interleaved (e.g., via RRC parameters, DCI, uplink control information (UCI), among other examples of information), such that the receiving device 215 expects output signal 225 to include one or more interleaved code blocks 230. Additionally or alternatively, the transmitting device 205 may indicate the interleaving pattern to the receiving device 215.

The receiving device 215 may receive the output signal 225 and determine the sets of PRB bundles 235 included within the output signal 225. In some cases, the receiving device 215 may determine the PRB bundles 235 based on receiving information from the transmitting device 205 indicating the interleaved code blocks 230. The receiving device 215 may deinterleave the PRB bundles 235 according to a deinterleaving matrix. In some cases the deinterleaving matrix may deinterleave the PRB bundles 235 interleaved according to the interleaving matrix used by the transmitting device 205 to map the VRB bundles to the PRB bundles 235.

The devices in the wireless communications system 200 may implement enhanced interleaving techniques to increase diversity gain for communications (e.g., repetitions of data over one or more slots of the output signal 225). For example, a wireless device (e.g., the transmitting device 205, the receiving device 215) may identify one or more parameters of an interleaving pattern for one or more slots. Such parameters may enable the wireless device to implement different mapping schemes across the one or more slots (e.g., each slot may be associated with a different interleaving pattern, each slot may use a same interleaving pattern that is shifted in accordance with the one or more parameters for each slot, or any combination thereof, among other examples of mapping schemes as described herein). In some examples, the wireless device may be pre-configured with the one or more parameters or may receive an indication of the parameters (e.g., an RRC configuration, a MAC-CE indication, a DCI indication, etc.), or a combination thereof.

The wireless device may communicate in accordance with the one or more parameters (e.g., the wireless device may receive or send repetitions of data over one or more slots based on the parameters). In some examples, the one or more parameters may include one or more cyclic shifts for one or more slots. For example, a wireless device may shift interleaved VRBs by a value (e.g., a quantity of VRB bundles) for each slot of the one or more slots according to the one or more cyclic shifts corresponding to each slot. Additionally or alternatively, the one or more parameters may include at least one interleaving parameter for one or more slots, such as an indication of a quantity of rows of an interleaving table, among other examples of parameters as described herein. Thus, the wireless device may map VRBs to PRBs using different parameters for one or more slots, which may result in improved diversity gain and ensure reliable communications.

The described techniques may also enable a wireless device to dynamically implement interleaving patterns. For example, a wireless device may identify the type of a communications payload (e.g., a dominant type of uplink payload in each symbol of an uplink transmission from a UE to a base station). The wireless device may communicate based on the identified type. In some examples, the wireless device may implement an interleaving pattern based on the type of the uplink payload. In some other examples, the wireless device may refrain from processing (e.g., interleaving) a transmission based on the type of the uplink payload. In some cases, the wireless device may identify one or more parameters of the interleaving pattern according to the identified type (e.g., a quantity of code blocks, a quantity of rows of an interleaving matrix, etc.), for example, based on a pre-configuration of the wireless device or an RRC configuration.

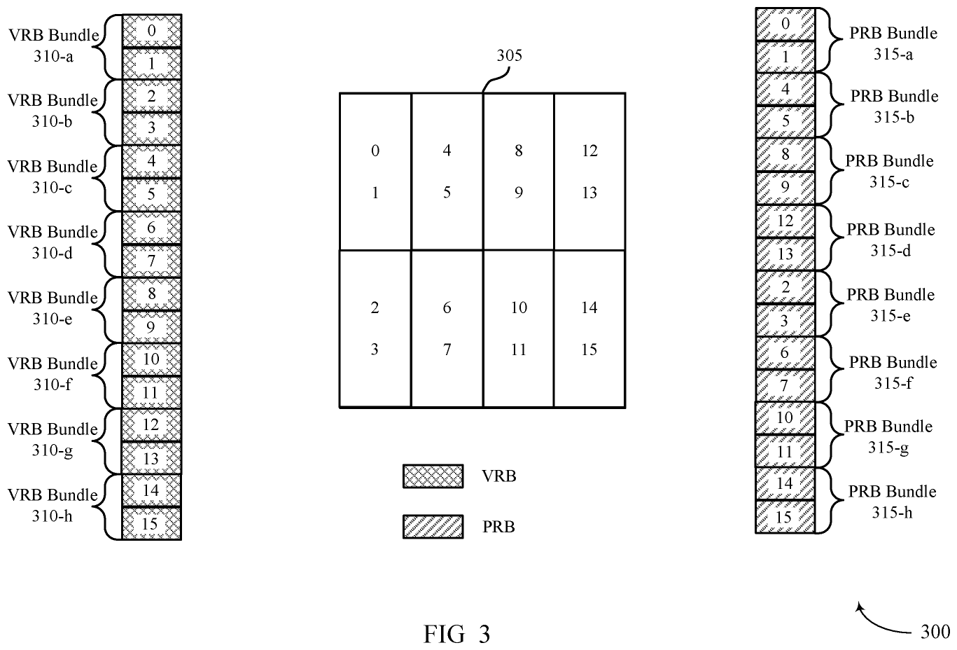

FIG. 3 illustrates an example of a mapping scheme 300 that supports interleaving techniques for wireless communications systems in accordance with aspects of the present disclosure. In some examples, the mapping scheme 300 may implement aspects of wireless communications systems 100 and 200. For example, the mapping scheme 300 may be implemented by one or more wireless devices as described with reference to FIGS. 1 and 2. Generally, the mapping scheme 300 illustrates an example of mapping VRBs to PRBs (e.g., interleaving VRB bundles 310 to PRB bundles 315) based on an interleaving pattern, a type of uplink transmission, or both, as described herein.

The mapping scheme 300 may include VRB bundles 310 and PRB bundles 315, which may be examples of VRB bundles and PRB bundles as described with reference to FIG. 2. The VRBs may correspond to an index. For example, the VRB bundle 310-a may include two VRBs corresponding to an index of 1 and 2, respectively, the VRB bundle 310-b may include two VRBs corresponding to an index of 3 and 4, respectively, and so on. A wireless device may implement the mapping scheme 300 to distribute one or more code blocks across frequency ranges, map multiple code blocks to an OFDM symbol (e.g., interleaving performed using the interleaving pattern within each code block) for relatively high bandwidth or data rates, or a combination thereof.

The VRBs may be mapped to the PRBs in accordance with an interleaving pattern, which may be shown for illustrative clarity as the interleaving matrix 305 (e.g., an interleaving grouping, an interleaving table, etc.). In some examples, the indices of the VRBs are input into the interleaving pattern and output to the PRBs, which may provide frequency and spatial diversity for communications.

For example, a wireless device may generate the interleaving matrix 305, for example, by writing VRB bundles 310 into the columns of the interleaving matrix 305 (e.g., the quantity of rows may be a predefined value, for example, two as shown in the interleaving matrix 305). For instance, the VRB bundle 310-a may be written into a first row of a first column of the interleaving matrix 305, the VRB bundle 310-a may be written into a second row of the first column, and so on, until the quantity of rows corresponding to the first column are filled. The VRB bundle 310-c may be written into the first row of a second column, the VRB bundle 310-d may be written into a second row of the second column, and so on, until the interleaving matrix 305 is full, or each of the VRBs has been allocated a location in the interleaving matrix.

In some examples, the indices in the generated interleaving matrix 305 may be read out, for example, by rows. As an illustrative example, the PRB bundle 315-a may be assigned to the VRB bundle 310-a (e.g., the first column of the first row may include the indices of the VRB bundle 310-a), the PRB bundle 315-b may be assigned to the VRB bundle 310-c (e.g., the second column of the first row may include the indices of the VRB bundle 310-c), and so on, until each of the VRB bundles 310 are mapped to a corresponding PRB bundle 315.

Although illustrated as an interleaving matrix 305 for clarity, in some examples a wireless device may map the VRBs and PRBs in accordance with the interleaving pattern by using one or more inputs, such as the indices of the VRBs, into one or more formulas or operations, and the interleaving pattern may include one or more interleaving parameters for the one or more formulas. For example, the interleaving parameters that may be used as part of a formula or an operation may include a quantity of RBs included in a bundle, a quantity of RBs in a BWP, a quantity of rows of an interleaving pattern, a quantity of columns of an interleaving pattern, or any combination thereof, among other examples of information that may be used for mapping VRBs to PRBs. In some examples, the one or more parameters of the interleaving pattern (e.g., the interleaving parameters) may be pre-configured at a device or indicated to the device (e.g., via RRC signaling, DCI, MAC-CEs, etc.).

In some examples, a wireless device may implement the mapping scheme 300 to increase diversity gain for communications (e.g., repetitions of data over one or more slots). For example, a wireless device may identify one or more parameters of an interleaving pattern for one or more slots. Such parameters may enable the wireless device to implement different interleaving patterns (e.g., interleaving matrices 305) across different slots (e.g., at least some slots if not each slot may be associated with a different interleaving matrix 305, at least some slots if not each slot may use a same interleaving matrix 305 that is shifted in accordance with one or more cyclic shifts corresponding to each slot, or any combination thereof, based on the one or more parameters).

For example, the wireless device may communicate in accordance with the one or more parameters (e.g., the wireless device may receive or send repetitions of data over one or more slots based on the parameters for each slot). In some examples, the one or more parameters may include one or more cyclic shifts for one or more slots. For example, a wireless device may shift interleaved VRBs by a value (e.g., a quantity of VRB bundles) for each slot of the one or more slots according to the one or more cyclic shifts corresponding to each slot. Additionally or alternatively, the one or more parameters may include at least one interleaving parameter for one or more slots, such as an indication of a quantity of rows to use for the interleaving matrix 305, one or more inputs for an interleaving formula, among other examples of parameters. Thus, the wireless device may map VRBs to PRBs using different parameters for one or more slots, which may result in improved diversity gain and ensure reliable communications, among other benefits.

Additionally or alternatively, the wireless device may dynamically implement an interleaving pattern, dynamically implement parameters of an interleaving pattern, or both based on a type of a communications payload. For example, the wireless device may receive information about a scheduled communication (e.g., a scheduled transmission or a scheduled reception). The wireless device may identify a dominant type of a payload in each symbol of a communication, such as a type of an uplink payload for a scheduled uplink transmission. In some examples, the wireless device may determine a quantity of code blocks (e.g., a quantity of PRBs) associated with each type of the uplink payload. In such examples, the wireless device may determine that the dominant type of the uplink payload is the type with a relatively higher quantity of code blocks (e.g., a higher quantity of PRBs) than other types of the uplink payload.

The wireless device may determine whether to interleave the VRBs (e.g., map a set of VRBs to a set of PRBs) based on the identified type of the uplink payload. In some examples, the wireless device may process the payload (e.g., interleave the code blocks of the payload) based on the identified type, such as an uplink shared data type, among other payload types (e.g., types of uplink payloads with a relatively large quantity of code blocks per OFDM symbol). In some other examples, the wireless device may refrain from processing the payload (e.g., the payload may be transmitted without interleaving) based on the identified type, such as an UCI payload type, among other payload types (e.g., types with a relatively low quantity of code blocks per OFDM symbol), which may result in relatively efficient communications.

In some examples, a quantity of code blocks in an OFDM symbol may be associated with a quantity of rows (e.g., a quantity of rows of the interleaving matrix 305 may result in a relatively better performance than a different quantity of rows for a given quantity of code blocks). For example, the wireless device may identify a quantity of code blocks per OFDM symbol for each of a set of payload types. The quantity of code blocks associated with a payload type may correspond to a quantity of rows, among other examples of interleaving parameters. In some examples, the connection between a quantity of rows (or other parameters) and a quantity of code blocks may be pre-configured at the wireless device, RRC configured, or both. Accordingly, the wireless device may use the quantity of rows associated with an identified uplink payload type to process the uplink transmission. By varying the quantity of rows (or other parameters associated with the interleaving pattern as described herein), the wireless device may realize improved frequency diversity and efficient communications.

As illustrative examples, the uplink payload types may include UCI types, such as a HARQ-ACK payload type, a CSI-Part1 payload type, a CSI-Part2 payload type, or any combination thereof. In some examples, such UCI payload types may correspond to one or two code blocks per OFDM symbol. A wireless device may refrain from interleaving UCI payload types based on the relatively low quantity of code blocks per OFDM symbol, or the wireless device may implement different parameters of an interleaving pattern (e.g., a quantity of rows, one or more inputs for an interleaving formula) for respective payload types. Additionally or alternatively, the uplink payload types may include data types, such as uplink shared channel (SCH) types. In some examples, such uplink SCH payload types may correspond to a relatively large quantity of code blocks per OFDM symbol. A wireless device may process the uplink transmission (e.g., implement VRB to PRB interleaving) in accordance with one or more parameters of an interleaving pattern (e.g., one or more parameters associated with the uplink payload type).

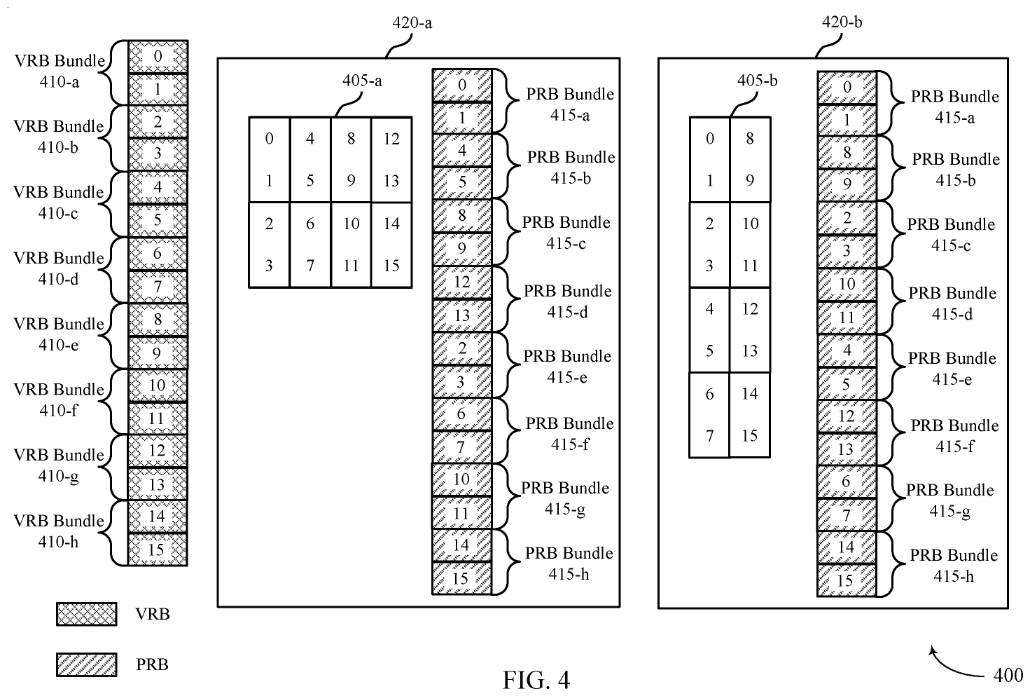

FIG. 4 illustrates an example of a mapping scheme 400 that supports interleaving techniques for wireless communications systems in accordance with aspects of the present disclosure. In some examples, the mapping scheme 400 may implement aspects of wireless communications systems 100 and 200. In some examples, the mapping scheme 400 may implement aspects of the mapping scheme 300. Generally, the mapping scheme 400 illustrates an example of slot specific VRB to PRB interleaving in accordance with one or more parameters of an interleaving pattern for one or more slots. As an illustrative example, a wireless device may implement a first interleaving pattern 420-a (e.g., generated using a first quantity of rows parameter, among other examples of interleaving parameters) for a first subset of slots of a set of slots and a second interleaving pattern 420-b (e.g., generated using a second quantity of rows parameter, among other examples of interleaving parameters) for a second subset of slots of the set of slots.

The mapping scheme 400 may include interleaving matrices 405, VRB bundles 410, and PRB bundles 415, which may be examples of the interleaving matrix 305, the VRB bundles 310, and the PRB bundles 315 as described with reference to FIG. 3. The mapping scheme 400 may illustrate an example of implementing interleaving patterns 420 across one or more slots based on one or more parameters associated with the interleaving patterns 420 (e.g., parameters associated with the interleaving patterns 420 for the one or more slots). In some examples, the one or more parameters may be identified based on each slot index (e.g., the one or more parameters may be slot specific), a total quantity of repeated slots (e.g., for repetitions of data, such as data re-transmissions as part of a HARQ procedure), or a combination thereof.

The interleaving pattern 420-a may include an interleaving matrix 405-a and the interleaving pattern 420-b may include an interleaving matrix 405-b. A wireless device may apply the interleaving pattern 420-a to one or more slots and apply the interleaving pattern 420-b to one or more slots. In some cases, the wireless device may apply the interleaving pattern 420-a to a portion of a set of slots (e.g., every other slot in the set of slots) and apply the interleaving pattern 420-b to a portion of a set of slots (e.g., the remaining slots in the set of slots). For example, a first slot may be interleaved in accordance with the interleaving matrix 405-a (e.g., resulting in a first mapping between the VRB bundles 410 and the PRB bundles 415 as illustrated in the interleaving pattern 420-a), a second slot may be interleaved in accordance with the interleaving matrix 405-b (e.g., resulting in a second mapping between the VRB bundles 410 and the PRB bundles 415 as illustrated in the interleaving pattern 420-b), a third slot may be interleaved in accordance with the interleaving matrix 405-a, and so on. Although, it is to be understood that any arrangement for applying one or more interleaving patterns 420 to one or more slots may be used.

A wireless device may generate the interleaving matrices 405 based on one or more parameters of the interleaving patterns 420. For example, the wireless device may identify one or more interleaving parameters associated with the interleaving pattern 420-a and generate the interleaving matrix 405-a based on the parameters. The interleaving parameters may include a quantity of rows, one or more cyclic shifts for the interleaving pattern 420, a quantity of RBs included in a bundle, a quantity of RBs in a BWP, a quantity of columns, or any combination thereof, among other examples of parameters used for mapping VRBs to PRBs. As an illustrative example, the mapping scheme 400 may show an example where the quantity of rows for the interleaving pattern 420-a may be configured as two and the quantity of rows for the interleaving pattern 420-b may be configured as four, although other values are possible.

In some examples, wireless device may identify an indication associated with an interleaving pattern 420. For example, the wireless device may receive a communication (e.g., a message) and identify a pre-configuration of the wireless device to implement for interleaving a subsequent communication, de-interleaving the received communication, or both. Additionally or alternatively, the wireless device may receive configuration information (e.g., an RRC configuration, a DCI indication, a MAC-CE indication, or any combination thereof). The wireless device may thus identify the one or more parameters of the interleaving patterns 420 based on the identified indication. For example, the pre-configuration or the configuration information may indicate one or more parameters of an interleaving pattern 420 to use for one or more slots (e.g., a first set of parameters to use for a first slot, a second set of parameters to use for a second slot, among other configurations).

The wireless device may communicate in accordance with the one or more parameters. For example, as described herein, the wireless device may apply different interleaving parameters (e.g., different interleaving matrices or formulas) for at least some of different slots, which may result in enhanced frequency diversity and more reliable communications. For example, if one or more PRBs are experiencing interference such as deep fading, the wireless device may ensure that communications are relatively more likely to be received by using different interleaving parameters across multiple slots of a data re-transmission (e.g., the same data may be transmitted in different physical resources in at least some if not each slot due to one or more interleaving parameters).

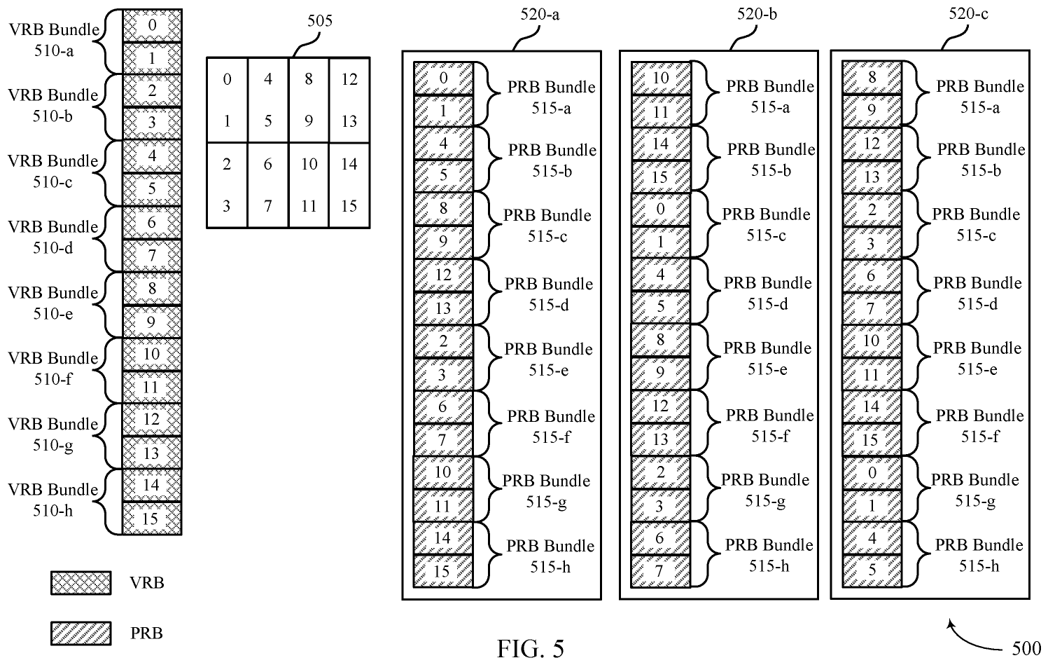

FIG. 5 illustrates an example of a mapping scheme 500 that supports interleaving techniques for wireless communications systems in accordance with aspects of the present disclosure. In some examples, the mapping scheme 500 may implement aspects of wireless communications systems 100 and 200. In some examples, the mapping scheme 500 may implement aspects of the mapping scheme 300 and the mapping scheme 400. Generally, the mapping scheme 500 illustrates an example of slot specific VRB to PRB interleaving.

The mapping scheme 500 may include interleaving matrices 505, VRB bundles 510, and PRB bundles 515, which may be examples of their respective elements as described with reference to FIGS. 3 and 4. The mapping scheme 500 may illustrate an example of implementing interleaving patterns 520 across one or more slots based on one or more parameters (e.g., parameters associated with the interleaving patterns 520 for the one or more slots). Specifically, the mapping scheme 500 illustrates various examples of cyclic shifts for the interleaving patterns 520 in accordance with aspects of the present disclosure.

A wireless device may identify one or more parameters of one or more interleaving patterns 520, for example, based on identifying an indication as described with reference to FIG. 4. In some examples, the one or more parameters may include one or more cyclic shifts for one or more slots. As an illustrative example, the wireless device may identify a first cyclic shift for a first interleaving pattern 520-a, a second cyclic shift for a second interleaving pattern 520-b, a third cyclic shift for the interleaving pattern 520-c, and so on. In some examples, the cyclic shifts may be identified based on a pre-configuration of the wireless device, information received from another wireless device (e.g., RRC information, DCI, MAC-CE indications, etc.), or a combination thereof.

The wireless device may implement the cyclic shifts to adjust a mapping of an interleaving pattern 520. For example, a cyclic shift may be in units of VRB bundles 510 (e.g., one VRB bundle 510, two VRB bundles 510, and so on). The wireless device may perform a cyclic shift to an output of an interleaving process (e.g., an interleaving or de-interleaving process using the interleaving matrix 505, one or more formulas, etc.) based on the value of the cyclic shift for the interleaving pattern 520 (e.g., based on a value of the cyclic shift for each slot in a set of slots). In some examples, performing a cyclic shift may include an operation of re-arranging the mappings between the VRBs and the PRBs such that the final position is moved to the first position (e.g., the indices of 14 and 15 in the interleaving pattern 520-a are moved to the PRB bundle 515-a) and all other positions are shifted to the next position (e.g., the indices 0 and 1 in the interleaving pattern 520-a are shifted to the PRB bundle 515-b). For example, the wireless device may map the VRB bundles 510 to the PRB bundles 515 using an interleaving matrix 505 (or one or more formulas) as described herein. Additionally or alternatively, the wireless device may use a cyclic shift to adjust the mapping of one or more interleaving patterns 520 (e.g., resulting in a different mapping of VRBs to PRBs for at least one slot in a set of slots).

For example, a cyclic shift of zero may result in a same mapping between VRB bundles 510 and PRB bundles 515 (i.e., the mapping between the VRB bundles 510 and the PRB bundles 515 may not be shifted after an interleaving process, such as interleaving or deinterleaving the PRB bundles 510 and PRB bundles 515 in accordance with the interleaving matrix 505, one or more formulas, among other examples of interleaving processes described herein). As an illustrative example, with a cyclic shift of zero, the VRB bundle 510-b may be mapped to the PRB bundle 515-e as shown in the interleaving pattern 520-a (e.g., due to reading out the indices 2 and 3 of the VRB bundle 510-b in the interleaving matrix 505 to the PRB bundle 515-e as described with reference to FIG. 3), the VRB bundle 510-c may be mapped to the PRB bundle 515-b as shown in the interleaving pattern 520-a (e.g., due to reading out the indices 4 and 5 of the VRB bundle 510-b in the interleaving matrix 505 to the PRB bundle 515-e as described with reference to FIG. 3), and so on.

As another illustrative example, a cyclic shift of two may result in a different mapping between VRB bundles 510 and PRB bundles 515 than a result of interleaving the VRB bundles 510 using an interleaving process (e.g., an interleaving or de-interleaving process using the interleaving matrix 505, one or more formulas, etc.). For example, a wireless device may identify a cyclic shift of two and shift a result of the interleaving matrix 505 by two VRB bundles 510, as shown in the interleaving pattern 520-b. In some examples, shifting the result of the interleaving matrix 505 may include cyclic shifting the mapping illustrated by the interleaving pattern 520-a. For example, a first VRB bundle 510-a (e.g., with VRB indices 0 and 1) may be mapped to the first PRB bundle 515-a (e.g., as shown in the interleaving pattern 520-a), and the wireless device may shift the mapping by two VRB bundles 510, such that the first VRB bundle 510-a is mapped to the PRB bundle 515-c (e.g., as shown in the interleaving pattern 520-b).

As another illustrative example, a cyclic shift of six may result in another different mapping between VRB bundles 510 and PRB bundles 515. For example, a wireless device may identify a cyclic shift of six and shift a result of an interleaving process (e.g., an interleaving or de-interleaving process using the interleaving matrix 505, one or more formulas, etc.) by six VRB bundles 510, as shown in the interleaving pattern 520-c. In some examples, shifting the result of the interleaving process may include cyclic shifting the mapping illustrated by the interleaving pattern 520-a (e.g., the cyclic shift of zero example). For example, a first VRB bundle 510-a (e.g., with VRB indices 0 and 1) may be mapped to the first PRB bundle 515-a (e.g., as shown in the interleaving pattern 520-a), and the wireless device may shift the mapping by six VRB bundles 510, such that the first VRB bundle 510-a is mapped to the PRB bundle 515-g (e.g., as shown in the interleaving pattern 520-c). In some examples, the cyclic shift may comprise any other quantity of units (e.g., quantity of VRB bundles 510 to shift) than the examples described in the mapping scheme 500.

In some examples, one or more different cyclic shifts may be configured for one or more slots (e.g., a different cyclic shift may be used for one or more if not each slot in a set of slots), the same cyclic shifts may be configured for one or more slots in a set of slots, or a combination thereof. For example, a wireless device may apply an interleaving pattern 520 to one or more slots of a set of slots in accordance with the mapping scheme 500 (e.g., the wireless device may interleave the VRB bundles 510 and the PRB bundles 515-a using an interleaving matrix 505 as described herein, and the wireless device may shift a result of the interleaving in a slot by a cyclic shift corresponding to that slot). As an illustrative example, the wireless device may apply the interleaving pattern 520-a to a first slot of a set of slots, the interleaving pattern 520-b to a second slot of a set of slots, the interleaving pattern 520-c to a third slot of a set of slots, and so on, although it is to be understood that any arrangement for applying one or more interleaving patterns 520 to one or more slots may be used.

In some examples, the wireless device may implement any combination of the techniques described herein. For example, the wireless device may identify one or more parameters (e.g., cyclic shifts, interleaving parameters, among other examples of parameters as described herein) and communicate in accordance with the parameters. Additionally or alternatively, the wireless device may determine whether to process communications (e.g., whether to implement interleaving for a transmission) or identify one or more parameters based on a type of a payload (or both), as described herein.

The wireless device may communicate in accordance with the one or more parameters. For example, the wireless device may apply cyclic shifts for one or more slots, which may result in enhanced frequency diversity and more reliable communications. For example, if one or more PRBs are experiencing interference such as deep fading, the wireless device may increase the likelihood that communications will be received by using different cyclic shifts to ensure that data transmissions (e.g., repetitions of data) across multiple slots may be transmitted in different physical resources at each slot.

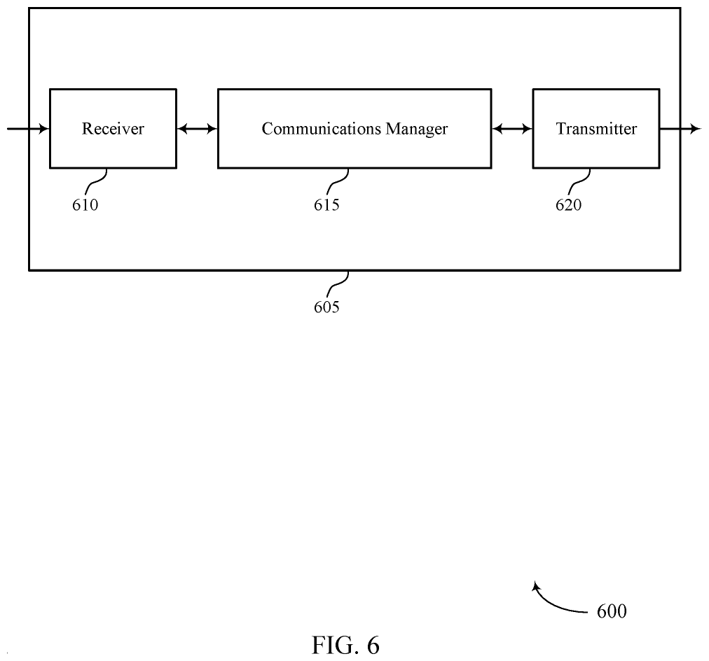

FIG. 6 shows a block diagram 600 of a device 605 that supports interleaving techniques for wireless communications systems in accordance with aspects of the present disclosure. The device 605 may be an example of aspects of a UE 115 as described herein. The device 605 may include a receiver 610, a communications manager 615, and a transmitter 620. The device 605 may also include a processor. Each of these components may be in communication with one another (e.g., via one or more buses).

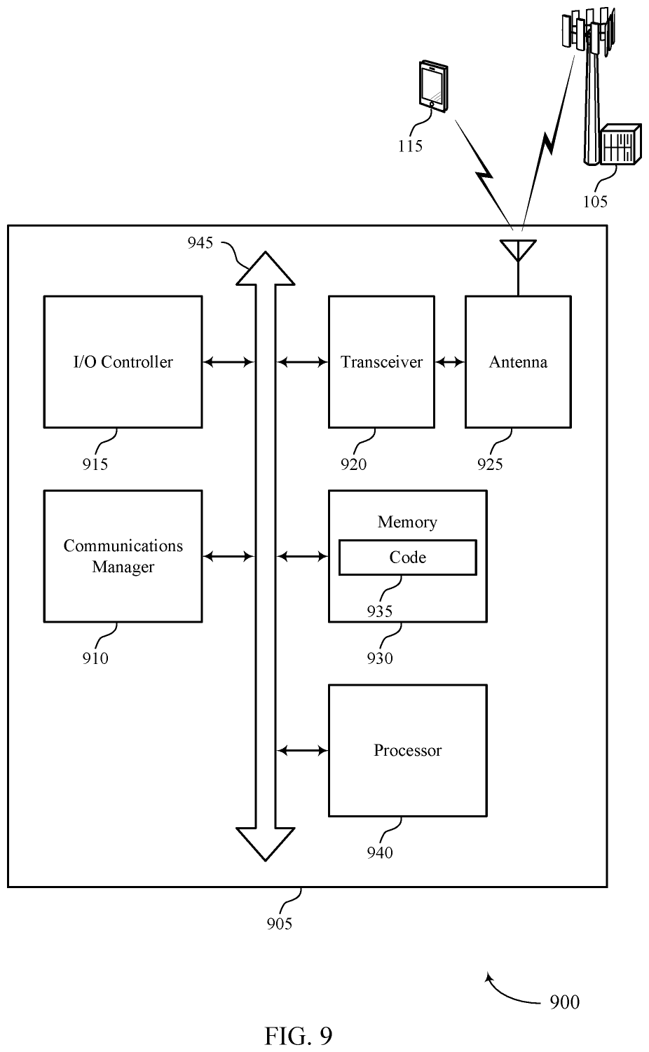

The receiver 610 may receive information such as packets, user data, or control information associated with various information channels (e.g., control channels, data channels, and information related to interleaving techniques for wireless communications systems, etc.). Information may be passed on to other components of the device 605. The receiver 610 may be an example of aspects of the transceiver 920 described with reference to FIG. 9. The receiver 610 may utilize a single antenna or a set of antennas.

The communications manager 615 may identify an interleaving pattern including a mapping between one or more virtual resource blocks and one or more physical resource blocks corresponding to a set of slots, the interleaving pattern including one or more parameters for at least a first slot corresponding to a repetition of data, perform an interleaving process based on the one or more parameters of the interleaving pattern, the one or more parameters including at least one different interleaving parameter for different slots, one or more cyclic shifts of the interleaving pattern for one or more slots, or both, and communicate, with a base station, the repetition of the data over the one or more slots based on the interleaving process. The communications manager 615 may also receive information from a base station scheduling an uplink transmission from the UE to the base station, identify an interleaving pattern for the uplink transmission based on a type of an uplink payload for the uplink transmission, the interleaving pattern including a mapping between one or more virtual resource blocks and one or more physical resource blocks, and transmit the uplink transmission to the base station based on the interleaving pattern. The communications manager 615 may be an example of aspects of the communications manager 910 described herein.

The communications manager 615, or its sub-components, may be implemented in hardware, code (e.g., software or firmware) executed by a processor, or any combination thereof. If implemented in code executed by a processor, the functions of the communications manager 615, or its sub-components may be executed by a general-purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described in the present disclosure.

The communications manager 615, or its sub-components, may be physically located at various positions, including being distributed such that portions of functions are implemented at different physical locations by one or more physical components. In some examples, the communications manager 615, or its sub-components, may be a separate and distinct component in accordance with various aspects of the present disclosure. In some examples, the communications manager 615, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The actions performed by the communications manager 615 as described herein may be implemented to realize one or more potential advantages. For example, identifying one or more parameters associated with an interleaving pattern for one or more slots (e.g., different interleaving parameters for different slots, different cyclic shifts for different slots, etc.) may ensure successful reception of data repetitions. For example, by mapping VRBs to PRBs differently for different slots, a wireless device may reduce the effects of interference such as deep fading in order to realize robust communications.

Additionally or alternatively, the communications manager 615 may be implemented to realize one or more potential advantages at the processor level. For example, the communications manager 615 may identify an uplink payload type, and communicate in accordance with the uplink payload type as described herein. In some examples, the communications manager 615 may refrain from interleaving an uplink transmission based on the payload type, which may result in more efficient communications. In some other examples, the communications manager 615 may interleave the uplink transmission based on the payload type, identify one or more parameters of the interleaving pattern based on the payload type, etc., which may result in more robust communications.

The transmitter 620 may transmit signals generated by other components of the device 605. In some examples, the transmitter 620 may be collocated with a receiver 610 in a transceiver module. For example, the transmitter 620 may be an example of aspects of the transceiver 920 described with reference to FIG. 9. The transmitter 620 may utilize a single antenna or a set of antennas.

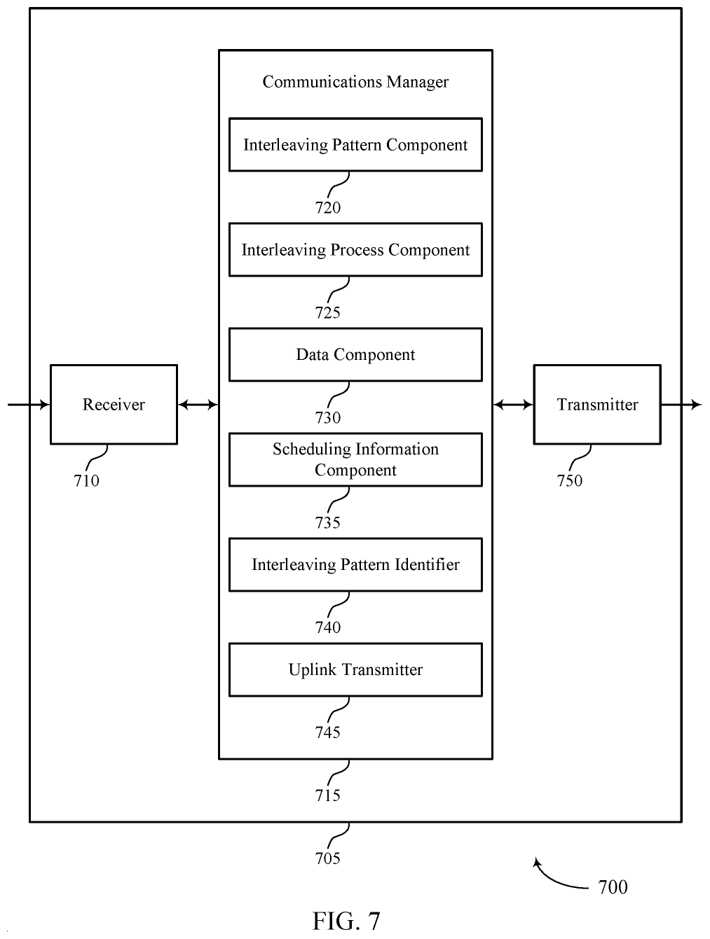

FIG. 7 shows a block diagram 700 of a device 705 that supports interleaving techniques for wireless communications systems in accordance with aspects of the present disclosure. The device 705 may be an example of aspects of a device 605, or a UE 115 as described herein. The device 705 may include a receiver 710, a communications manager 715, and a transmitter 750. The device 705 may also include a processor. Each of these components may be in communication with one another (e.g., via one or more buses).

The receiver 710 may receive information such as packets, user data, or control information associated with various information channels (e.g., control channels, data channels, and information related to interleaving techniques for wireless communications systems, etc.). Information may be passed on to other components of the device 705. The receiver 710 may be an example of aspects of the transceiver 920 described with reference to FIG. 9. The receiver 710 may utilize a single antenna or a set of antennas.

The communications manager 715 may be an example of aspects of the communications manager 615 as described herein. The communications manager 715 may include an interleaving pattern component 720, an interleaving process component 725, a data component 730, a scheduling information component 735, an interleaving pattern identifier 740, and an uplink transmitter 745. The communications manager 715 may be an example of aspects of the communications manager 910 described herein.

The communications manager 715, or its sub-components, may be implemented in hardware, code (e.g., software or firmware) executed by a processor, or any combination thereof. If implemented in code executed by a processor, the functions of the communications manager 715, or its sub-components may be executed by a general-purpose processor, a DSP, an ASIC, an FPGA or other programmable logic device, discrete gate or transistor logic, discrete hardware components, or any combination thereof designed to perform the functions described in the present disclosure.

The communications manager 715, or its sub-components, may be physically located at various positions, including being distributed such that portions of functions are implemented at different physical locations by one or more physical components. In some examples, the communications manager 715, or its sub-components, may be a separate and distinct component in accordance with various aspects of the present disclosure. In some examples, the communications manager 715, or its sub-components, may be combined with one or more other hardware components, including but not limited to an I/O component, a transceiver, a network server, another computing device, one or more other components described in the present disclosure, or a combination thereof in accordance with various aspects of the present disclosure.

The interleaving pattern component 720 may identify an interleaving pattern including a mapping between one or more virtual resource blocks and one or more physical resource blocks corresponding to a set of slots, the interleaving pattern including one or more parameters for at least a first slot corresponding to a repetition of data.

The interleaving process component 725 may perform an interleaving process based on the one or more parameters of the interleaving pattern, the one or more parameters including at least one different interleaving parameter for different slots, one or more cyclic shifts of the interleaving pattern for one or more slots, or both.

The data component 730 may communicate, with a base station, the repetition of the data over the one or more slots based on the interleaving process.

The scheduling information component 735 may receive information from a base station scheduling an uplink transmission from the UE to the base station.

The interleaving pattern identifier 740 may identify an interleaving pattern for the uplink transmission based on a type of an uplink payload for the uplink transmission, the interleaving pattern including a mapping between one or more virtual resource blocks and one or more physical resource blocks.

The uplink transmitter 745 may transmit the uplink transmission to the base station based on the interleaving pattern.

The transmitter 750 may transmit signals generated by other components of the device 705. In some examples, the transmitter 750 may be collocated with a receiver 710 in a transceiver module. For example, the transmitter 750 may be an example of aspects of the transceiver 920 described with reference to FIG. 9. The transmitter 750 may utilize a single antenna or a set of antennas.

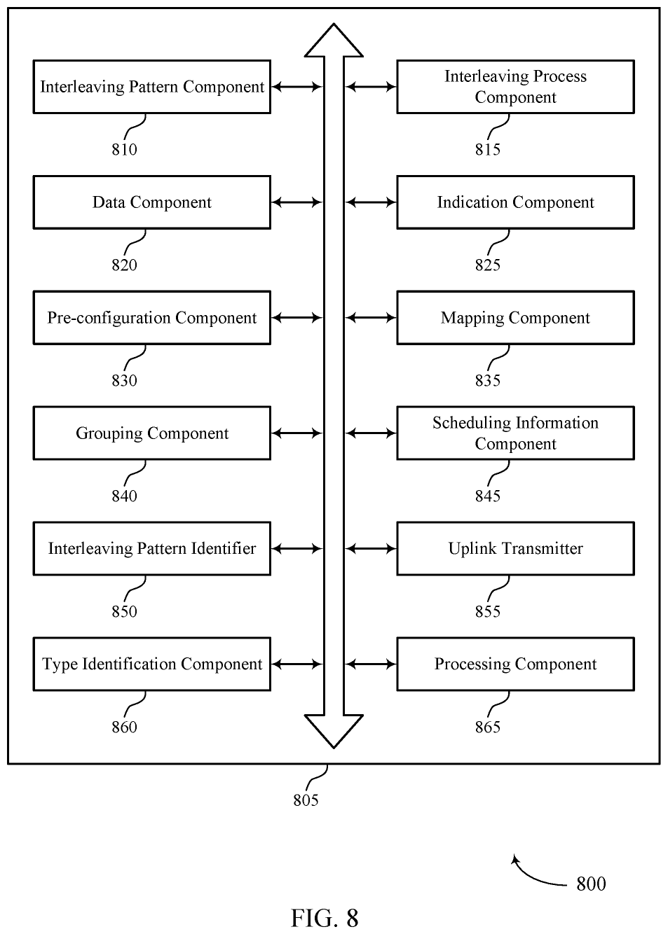

FIG. 8 shows a block diagram 800 of a communications manager 805 that supports interleaving techniques for wireless communications systems in accordance with aspects of the present disclosure. The communications manager 805 may be an example of aspects of a communications manager 615, a communications manager 715, or a communications manager 910 described herein. The communications manager 805 may include an interleaving pattern component 810, an interleaving process component 815, a data component 820, an indication component 825, a pre-configuration component 830, a mapping component 835, a grouping component 840, a scheduling information component 845, an interleaving pattern identifier 850, an uplink transmitter 855, a type identification component 860, and a processing component 865. Each of these modules may communicate, directly or indirectly, with one another (e.g., via one or more buses).

The communications manager 805, or its sub-components, may be implemented in hardware, code (e.g., software or firmware) executed by a processor, or any combination thereof. If implemented in code executed by a processor, the functions of the communications manager 805, or its sub-components may be executed by a general-purpose processor, a DSP, an ASIC, an FPGA or other programmable logic device, discrete gate or transistor logic, discrete hardware components, or any combination thereof designed to perform the functions described in the present disclosure.

The communications manager 805, or its sub-components, may be physically located at various positions, including being distributed such that portions of functions are implemented at different physical locations by one or more physical components. In some examples, the communications manager 805, or its sub-components, may be a separate and distinct component in accordance with various aspects of the present disclosure. In some examples, the communications manager 805, or its sub-components, may be combined with one or more other hardware components, including but not limited to an I/O component, a transceiver, a network server, another computing device, one or more other components described in the present disclosure, or a combination thereof in accordance with various aspects of the present disclosure.

The interleaving pattern component 810 may identify an interleaving pattern including a mapping between one or more virtual resource blocks and one or more physical resource blocks corresponding to a set of slots, the interleaving pattern including one or more parameters for at least a first slot corresponding to a repetition of data.

In some examples, the interleaving pattern component 810 may identify the one or more parameters of the interleaving pattern based on a pre-configuration associated with the interleaving pattern, a configuration received from a base station, or a combination thereof.

In some examples, the interleaving pattern component 810 may identify the one or more parameters of the interleaving pattern for at least the first slot based on a slot index of the first slot, a total number of slots corresponding to the repetition of the data, or both.

The interleaving process component 815 may perform an interleaving process based on the one or more parameters of the interleaving pattern, the one or more parameters including at least one different interleaving parameter for different slots, one or more cyclic shifts of the interleaving pattern for one or more slots, or both.

In some examples, the interleaving process component 815 may interleave the one or more virtual resource blocks and the one or more physical resource blocks in accordance with the one or more parameters, where transmitting the repetition of the data is based on the interleaving. In some examples, the interleaving process component 815 may deinterleave the one or more virtual resource blocks and the one or more physical resource blocks in accordance with the one or more parameters based on receiving the repetition of the data.

The data component 820 may communicate, with a base station, the repetition of the data over the one or more slots based on the interleaving process. In some examples, the data component 820 may transmit the repetition of the data over an uplink shared channel. In some examples, the data component 820 may receive the repetition of the data over a downlink shared channel. In some examples, the data component 820 may transmit the uplink transmission based on the interleaving pattern based on the identified type of the uplink payload.

In some examples, the data component 820 may refrain from processing the uplink transmission based on the interleaving pattern based on the identified type of the uplink payload, where communicating the repetition of the data is based on refraining from processing the uplink transmission.

The scheduling information component 845 may receive information from a base station scheduling an uplink transmission from the UE to the base station. In some examples, the scheduling information component 845 may receive information from the base station scheduling an uplink transmission from the UE to the base station. In some examples, the scheduling information component 845 may receive second information from the base station scheduling a second uplink transmission from the UE to the base station.

The interleaving pattern identifier 850 may identify an interleaving pattern for the uplink transmission based on a type of an uplink payload for the uplink transmission, the interleaving pattern including a mapping between one or more virtual resource blocks and one or more physical resource blocks. In some examples, the interleaving pattern identifier 850 may identify a type of an uplink payload for the uplink transmission, where identifying the one or more parameters of the interleaving pattern is based on identifying the type of the uplink payload.

In some examples, the interleaving pattern identifier 850 may identify an interleaving parameter associated with the type of the uplink payload based on a quantity of code blocks corresponding to the type of the uplink payload. In some examples, the interleaving pattern identifier 850 may identify the interleaving parameter is based on receiving a pre-configuration of the interleaving pattern, a radio resource control configuration from the base station, or any combination thereof.

In some examples, the interleaving pattern identifier 850 may identify one or more parameters of the interleaving pattern for at least a first slot corresponding to a repetition of data based on a pre-configuration, an indication from the base station, or both, where the one or more parameters include at least one different interleaving parameter for different slots, one or more cyclic shifts of the interleaving pattern for one or more slots, or both.

The uplink transmitter 855 may transmit the uplink transmission to the base station based on the interleaving pattern.

The indication component 825 may receive an indication from the base station, where identifying the one or more parameters is based on the indication, and where the indication includes a radio resource control configuration, a medium access control control element indication, a downlink control information indication, or any combination thereof. In some examples, the indication component 825 may receive a communication from the base station.

The pre-configuration component 830 may identify the pre-configuration associated with the interleaving pattern based on the received communication, where identifying the one or more parameters is based on the pre-configuration.

The mapping component 835 may identify the mapping between the one or more virtual resource blocks and the one or more physical resource blocks corresponding to the set of slots. In some examples, the mapping component 835 may adjust the mapping for the first slot based on a cyclic shift for the first slot of the one or more cyclic shifts, where the interleaving pattern includes the adjusted mapping for the first slot. In some examples, the mapping component 835 may adjust the mapping for a second slot of the set of slots based on a cyclic shift for the second slot of the one or more cyclic shifts, where the interleaving pattern includes the adjusted mapping for the second slot.

In some examples, the mapping component 835 may adjust a correspondence for a first virtual resource block bundle from a first portion of the one or more physical resource blocks to a second portion of the one or more physical resource blocks in accordance with the cyclic shift for the first slot, where the cyclic shift for the first slot indicates a quantity of virtual resource block bundles between the first portion of the one or more physical resource blocks and the second portion of the one or more physical resource blocks.

In some examples, the mapping component 835 may identify a first mapping between one or more virtual resource blocks and one or more physical resource blocks of the interleaving pattern based on the first grouping, where communicating the repetition of the data over the first slot of the one or more slots is based on the first mapping. In some examples, the mapping component 835 may identify a second mapping between the one or more virtual resource blocks and the one or more physical resource blocks of the interleaving pattern based on the second grouping, where communicating the repetition of the data over a second slot of the one or more slots is based on the second mapping.

The grouping component 840 may generate a first grouping corresponding to the first slot based on a first interleaving parameter of the at least one different interleaving parameter, the first interleaving parameter corresponding to the first slot. In some examples, the grouping component 840 may generate a second grouping corresponding to a second slot based on a second interleaving parameter of the at least one different interleaving parameter, the second interleaving parameter corresponding to the second slot.

The type identification component 860 may identify the type of the uplink payload for the uplink transmission based on the information from the base station. In some examples, the type identification component 860 may identify that the type of the uplink payload in one or more symbols of the uplink transmission includes a higher quantity of the one or more physical resource blocks than a second type of the uplink payload in the one or more symbols of the uplink transmission.

In some examples, the type identification component 860 may identify a second type of a second uplink payload for the second uplink transmission. In some cases, the type of the uplink payload includes a hybrid automatic repeat request acknowledgment type, a first channel status information type, a second channel status information type, an uplink shared channel data type, or any combination thereof. In some cases, the second type of the second uplink payload includes an uplink control information type.

The processing component 865 may refrain from processing the second uplink transmission based on the interleaving pattern.

FIG. 9 shows a diagram of a system 900 including a device 905 that supports interleaving techniques for wireless communications systems in accordance with aspects of the present disclosure. The device 905 may be an example of or include the components of device 605, device 705, or a UE 115 as described herein. The device 905 may include components for bi-directional voice and data communications including components for transmitting and receiving communications, including a communications manager 910, an I/O controller 915, a transceiver 920, an antenna 925, memory 930, and a processor 940. These components may be in electronic communication via one or more buses (e.g., bus 945).

The communications manager 910 may identify an interleaving pattern including a mapping between one or more virtual resource blocks and one or more physical resource blocks corresponding to a set of slots, the interleaving pattern including one or more parameters for at least a first slot corresponding to a repetition of data, perform an interleaving process based on the one or more parameters of the interleaving pattern, the one or more parameters including at least one different interleaving parameter for different slots, one or more cyclic shifts of the interleaving pattern for one or more slots, or both, and communicate, with a base station, the repetition of the data over the one or more slots based on the interleaving process. The communications manager 910 may also receive information from a base station scheduling an uplink transmission from the UE to the base station, identify an interleaving pattern for the uplink transmission based on a type of an uplink payload for the uplink transmission, the interleaving pattern including a mapping between one or more virtual resource blocks and one or more physical resource blocks, and transmit the uplink transmission to the base station based on the interleaving pattern.

The communications manager 910, or its sub-components, may be implemented in hardware, code (e.g., software or firmware) executed by a processor, or any combination thereof. If implemented in code executed by a processor, the functions of the communications manager 910, or its sub-components may be executed by a general-purpose processor, a DSP, an ASIC, an FPGA or other programmable logic device, discrete gate or transistor logic, discrete hardware components, or any combination thereof designed to perform the functions described in the present disclosure.

The communications manager 910, or its sub-components, may be physically located at various positions, including being distributed such that portions of functions are implemented at different physical locations by one or more physical components. In some examples, the communications manager 910, or its sub-components, may be a separate and distinct component in accordance with various aspects of the present disclosure. In some examples, the communications manager 910, or its sub-components, may be combined with one or more other hardware components, including but not limited to an I/O component, a transceiver, a network server, another computing device, one or more other components described in the present disclosure, or a combination thereof in accordance with various aspects of the present disclosure.

The I/O controller 915 may manage input and output signals for the device 905. The I/O controller 915 may also manage peripherals not integrated into the device 905. In some cases, the I/O controller 915 may represent a physical connection or port to an external peripheral. In some cases, the I/O controller 915 may utilize an operating system such as iOS®, ANDROID®, MS-DOS®, MS-WINDOWS®, OS/2®, UNIX®, LINUX®, or another known operating system. In other cases, the I/O controller 915 may represent or interact with a modem, a keyboard, a mouse, a touchscreen, or a similar device. In some cases, the I/O controller 915 may be implemented as part of a processor. In some cases, a user may interact with the device 905 via the I/O controller 915 or via hardware components controlled by the I/O controller 915.

The transceiver 920 may communicate bi-directionally, via one or more antennas, wired, or wireless links as described above. For example, the transceiver 920 may represent a wireless transceiver and may communicate bi-directionally with another wireless transceiver. The transceiver 920 may also include a modem to modulate the packets and provide the modulated packets to the antennas for transmission, and to demodulate packets received from the antennas.

In some cases, the wireless device may include a single antenna 925. However, in some cases the device may have more than one antenna 925, which may be capable of concurrently transmitting or receiving multiple wireless transmissions.

The memory 930 may include random-access memory (RAM) and read-only memory (ROM). The memory 930 may store computer-readable, computer-executable code 935 including instructions that, when executed, cause the processor to perform various functions described herein. In some cases, the memory 930 may contain, among other things, a basic I/O system (BIOS) which may control basic hardware or software operation such as the interaction with peripheral components or devices.

The processor 940 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In other cases, a memory controller may be integrated into the processor 940. The processor 940 may be configured to execute computer-readable instructions stored in a memory (e.g., the memory 930) to cause the device 905 to perform various functions (e.g., functions or tasks supporting interleaving techniques for wireless communications systems).

The code 935 may include instructions to implement aspects of the present disclosure, including instructions to support wireless communications. The code 935 may be stored in a non-transitory computer-readable medium such as system memory or other type of memory. In some cases, the code 935 may not be directly executable by the processor 940 but may cause a computer (e.g., when compiled and executed) to perform functions described herein.

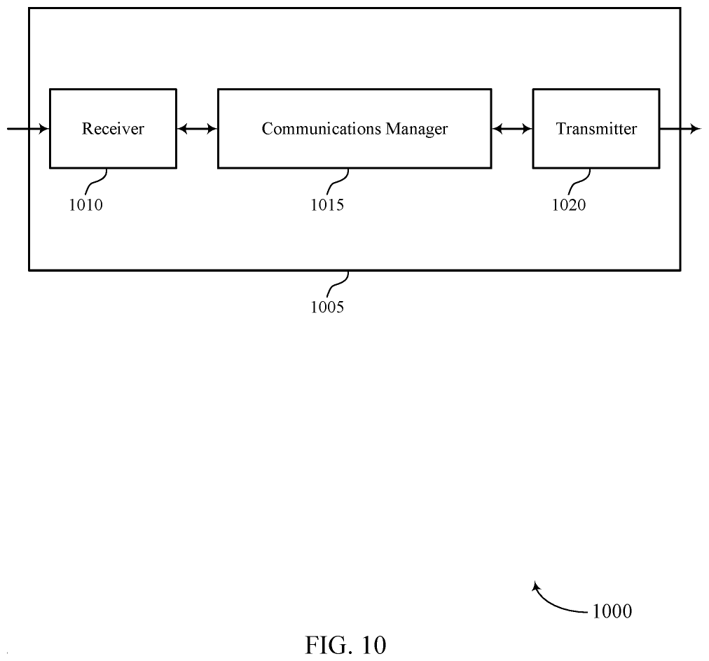

FIG. 10 shows a block diagram 1000 of a device 1005 that supports interleaving techniques for wireless communications systems in accordance with aspects of the present disclosure. The device 1005 may be an example of aspects of a base station 105 as described herein. The device 1005 may include a receiver 1010, a communications manager 1015, and a transmitter 1020. The device 1005 may also include a processor. Each of these components may be in communication with one another (e.g., via one or more buses).

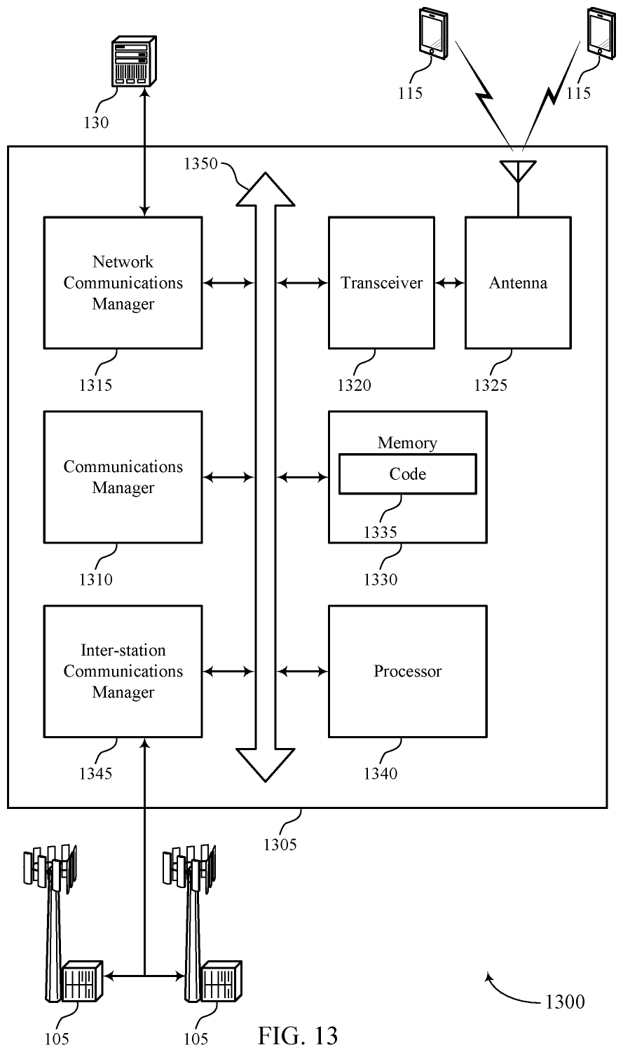

The receiver 1010 may receive information such as packets, user data, or control information associated with various information channels (e.g., control channels, data channels, and information related to interleaving techniques for wireless communications systems, etc.). Information may be passed on to other components of the device 1005. The receiver 1010 may be an example of aspects of the transceiver 1320 described with reference to FIG. 13. The receiver 1010 may utilize a single antenna or a set of antennas.

The communications manager 1015 may identify an interleaving pattern including a mapping between one or more virtual resource blocks and one or more physical resource blocks corresponding to a set of slots, the interleaving pattern including one or more parameters at least a first slot corresponding to a repetition of data, perform an interleaving process based on the one or more parameters of the interleaving pattern, the one or more parameters including at least one different interleaving parameter for different slots, one or more cyclic shifts of the interleaving pattern for one or more slots, or both, and communicate, with a UE, the repetition of the one or more slots based on the interleaving process. The communications manager 1015 may also transmit information to a UE scheduling an uplink transmission from the UE to the base station, the uplink transmission corresponding to a type of an uplink payload for the uplink transmission, receive the uplink transmission based on the transmitted information, identify an interleaving pattern for the uplink transmission based on the type of the uplink payload, the interleaving pattern including a mapping between one or more virtual resource blocks and one or more physical resource blocks, and process the uplink transmission based on the identified interleaving pattern. The communications manager 1015 may be an example of aspects of the communications manager 1310 described herein.

The communications manager 1015, or its sub-components, may be implemented in hardware, code (e.g., software or firmware) executed by a processor, or any combination thereof. If implemented in code executed by a processor, the functions of the communications manager 1015, or its sub-components may be executed by a general-purpose processor, a DSP, an ASIC, an FPGA or other programmable logic device, discrete gate or transistor logic, discrete hardware components, or any combination thereof designed to perform the functions described in the present disclosure.

The communications manager 1015, or its sub-components, may be physically located at various positions, including being distributed such that portions of functions are implemented at different physical locations by one or more physical components. In some examples, the communications manager 1015, or its sub-components, may be a separate and distinct component in accordance with various aspects of the present disclosure. In some examples, the communications manager 1015, or its sub-components, may be combined with one or more other hardware components, including but not limited to an I/O component, a transceiver, a network server, another computing device, one or more other components described in the present disclosure, or a combination thereof in accordance with various aspects of the present disclosure.

The transmitter 1020 may transmit signals generated by other components of the device 1005. In some examples, the transmitter 1020 may be collocated with a receiver 1010 in a transceiver module. For example, the transmitter 1020 may be an example of aspects of the transceiver 1320 described with reference to FIG. 13. The transmitter 1020 may utilize a single antenna or a set of antennas.

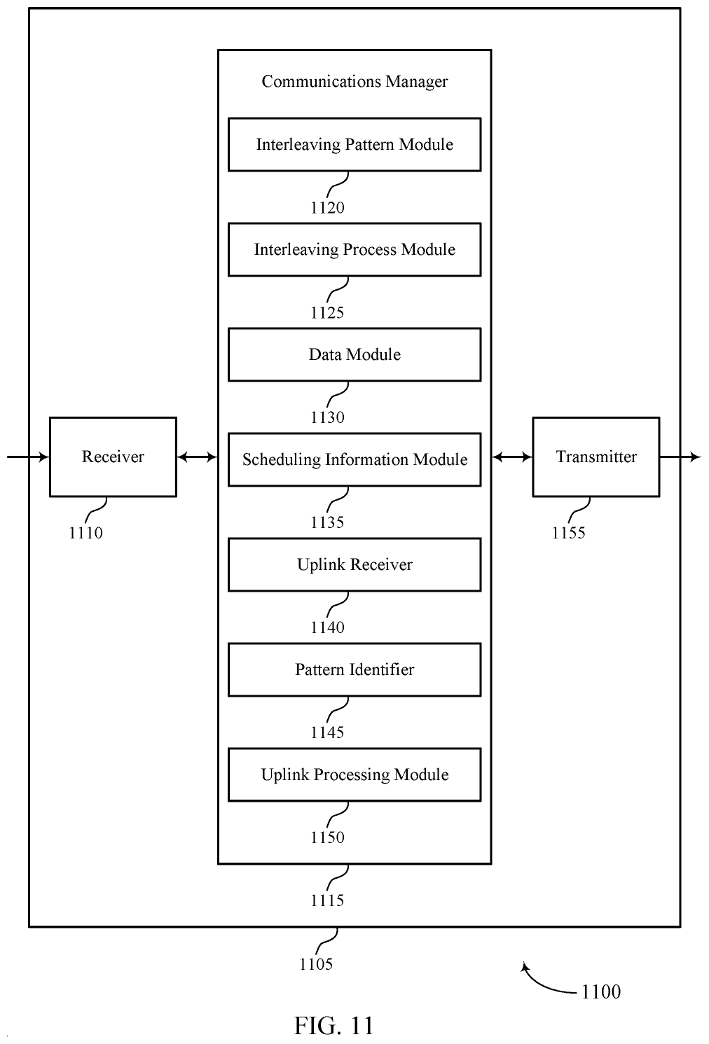

FIG. 11 shows a block diagram 1100 of a device 1105 that supports interleaving techniques for wireless communications systems in accordance with aspects of the present disclosure. The device 1105 may be an example of aspects of a device 1005, or a base station 105 as described herein. The device 1105 may include a receiver 1110, a communications manager 1115, and a transmitter 1155. The device 1105 may also include a processor. Each of these components may be in communication with one another (e.g., via one or more buses).

The receiver 1110 may receive information such as packets, user data, or control information associated with various information channels (e.g., control channels, data channels, and information related to interleaving techniques for wireless communications systems, etc.). Information may be passed on to other components of the device 1105. The receiver 1110 may be an example of aspects of the transceiver 1320 described with reference to FIG. 13. The receiver 1110 may utilize a single antenna or a set of antennas.

The communications manager 1115 may be an example of aspects of the communications manager 1015 as described herein. The communications manager 1115 may include an interleaving pattern module 1120, an interleaving process module 1125, a data module 1130, a scheduling information module 1135, an uplink receiver 1140, a pattern identifier 1145, and an uplink processing module 1150. The communications manager 1115 may be an example of aspects of the communications manager 1310 described herein.

The communications manager 1115, or its sub-components, may be implemented in hardware, code (e.g., software or firmware) executed by a processor, or any combination thereof. If implemented in code executed by a processor, the functions of the communications manager 1115, or its sub-components may be executed by a general-purpose processor, a DSP, an ASIC, an FPGA or other programmable logic device, discrete gate or transistor logic, discrete hardware components, or any combination thereof designed to perform the functions described in the present disclosure.

The communications manager 1115, or its sub-components, may be physically located at various positions, including being distributed such that portions of functions are implemented at different physical locations by one or more physical components. In some examples, the communications manager 1115, or its sub-components, may be a separate and distinct component in accordance with various aspects of the present disclosure. In some examples, the communications manager 1115, or its sub-components, may be combined with one or more other hardware components, including but not limited to an I/O component, a transceiver, a network server, another computing device, one or more other components described in the present disclosure, or a combination thereof in accordance with various aspects of the present disclosure.

The interleaving pattern module 1120 may identify an interleaving pattern including a mapping between one or more virtual resource blocks and one or more physical resource blocks corresponding to a set of slots, the interleaving pattern including one or more parameters at least a first slot corresponding to a repetition of data.

The interleaving process module 1125 may perform an interleaving process based on the one or more parameters of the interleaving pattern, the one or more parameters including at least one different interleaving parameter for different slots, one or more cyclic shifts of the interleaving pattern for one or more slots, or both.

The data module 1130 may communicate, with a UE, the repetition of the one or more slots based on the interleaving process.

The scheduling information module 1135 may transmit information to a UE scheduling an uplink transmission from the UE to the base station, the uplink transmission corresponding to a type of an uplink payload for the uplink transmission.

The uplink receiver 1140 may receive the uplink transmission based on the transmitted information.

The pattern identifier 1145 may identify an interleaving pattern for the uplink transmission based on the type of the uplink payload, the interleaving pattern including a mapping between one or more virtual resource blocks and one or more physical resource blocks.

The uplink processing module 1150 may process the uplink transmission based on the identified interleaving pattern.

The transmitter 1155 may transmit signals generated by other components of the device 1105. In some examples, the transmitter 1155 may be collocated with a receiver 1110 in a transceiver module. For example, the transmitter 1155 may be an example of aspects of the transceiver 1320 described with reference to FIG. 13. The transmitter 1155 may utilize a single antenna or a set of antennas.

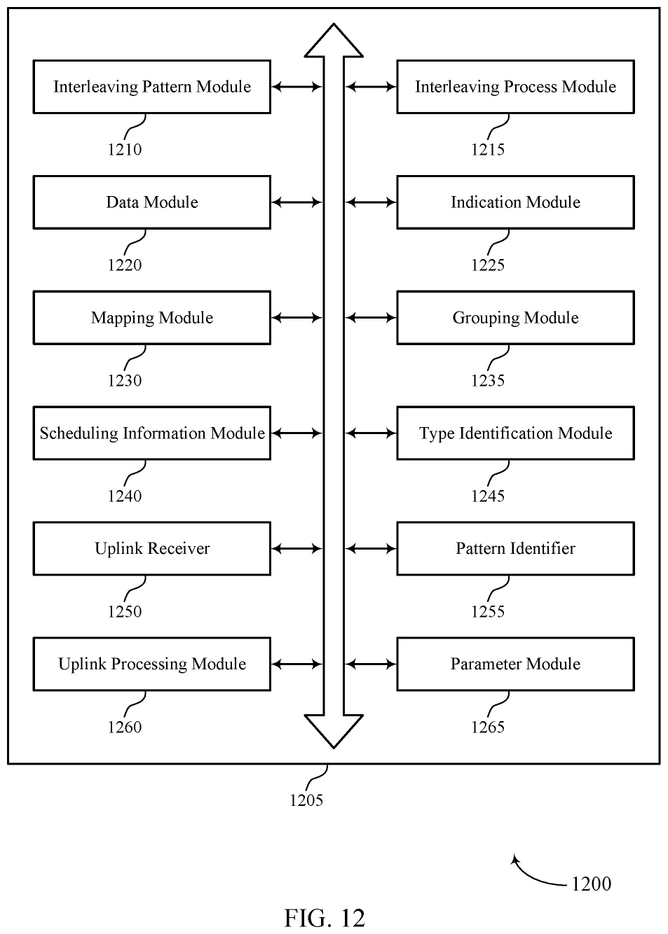

FIG. 12 shows a block diagram 1200 of a communications manager 1205 that supports interleaving techniques for wireless communications systems in accordance with aspects of the present disclosure. The communications manager 1205 may be an example of aspects of a communications manager 1015, a communications manager 1115, or a communications manager 1310 described herein. The communications manager 1205 may include an interleaving pattern module 1210, an interleaving process module 1215, a data module 1220, an indication module 1225, a mapping module 1230, a grouping module 1235, a scheduling information module 1240, a type identification module 1245, an uplink receiver 1250, a pattern identifier 1255, an uplink processing module 1260, and a parameter module 1265. Each of these modules may communicate, directly or indirectly, with one another (e.g., via one or more buses).

The communications manager 1205, or its sub-components, may be implemented in hardware, code (e.g., software or firmware) executed by a processor, or any combination thereof. If implemented in code executed by a processor, the functions of the communications manager 1205, or its sub-components may be executed by a general-purpose processor, a DSP, an ASIC, an FPGA or other programmable logic device, discrete gate or transistor logic, discrete hardware components, or any combination thereof designed to perform the functions described in the present disclosure.

The communications manager 1205, or its sub-components, may be physically located at various positions, including being distributed such that portions of functions are implemented at different physical locations by one or more physical components. In some examples, the communications manager 1205, or its sub-components, may be a separate and distinct component in accordance with various aspects of the present disclosure. In some examples, the communications manager 1205, or its sub-components, may be combined with one or more other hardware components, including but not limited to an I/O component, a transceiver, a network server, another computing device, one or more other components described in the present disclosure, or a combination thereof in accordance with various aspects of the present disclosure.

The interleaving pattern module 1210 may identify an interleaving pattern including a mapping between one or more virtual resource blocks and one or more physical resource blocks corresponding to a set of slots, the interleaving pattern including one or more parameters at least a first slot corresponding to a repetition of data. In some examples, the interleaving pattern module 1210 may identify the one or more parameters of the interleaving pattern based on a pre-configuration associated with the interleaving pattern, an indication of the one or more parameters of the interleaving pattern, or a combination thereof.

In some examples, the interleaving pattern module 1210 may identify the one or more parameters of the interleaving pattern for at least the first slot is based on a slot index of the first slot, a total number of slots corresponding to the repetition of the data, or both.

In some examples, the interleaving pattern module 1210 may identify one or more parameters of the interleaving pattern for at least a first slot corresponding to a repetition of data based on a pre-configuration, an indication from the base station, or both, where the one or more parameters include at least one different interleaving parameter for different slots, one or more cyclic shifts of the interleaving pattern for one or more slots, or both.

The interleaving process module 1215 may perform an interleaving process based on the one or more parameters of the interleaving pattern, the one or more parameters including at least one different interleaving parameter for different slots, one or more cyclic shifts of the interleaving pattern for one or more slots, or both.

In some examples, the interleaving process module 1215 may deinterleave the one or more virtual resource blocks and the one or more physical resource blocks in accordance with the one or more parameters based on receiving the repetition of the data. In some examples, the interleaving process module 1215 may interleave the one or more virtual resource blocks and the one or more physical resource blocks in accordance with the one or more parameters, where transmitting the repetition of the data is based on the interleaving.

In some examples, the interleaving process module 1215 may refrain from processing the uplink transmission based on the interleaving pattern based on the identified type of the uplink payload, where communicating the repetition of the data is based on refraining from processing the uplink transmission.

The data module 1220 may communicate, with a UE, the repetition of the one or more slots based on the interleaving process. In some examples, the data module 1220 may receive the repetition of the data over an uplink shared channel. In some examples, the data module 1220 may transmit the repetition of the data over a downlink shared channel. In some examples, the data module 1220 may receive the uplink transmission based on the interleaving pattern based on the identified type of the uplink payload.

The scheduling information module 1240 may transmit information to a UE scheduling an uplink transmission from the UE to the base station, the uplink transmission corresponding to a type of an uplink payload for the uplink transmission. In some examples, the scheduling information module 1240 may transmit information to the UE scheduling an uplink transmission from the UE to the base station. In some examples, the scheduling information module 1240 may transmit second information to the UE scheduling a second uplink transmission from the UE to the base station.

The uplink receiver 1250 may receive the uplink transmission based on the transmitted information.

The pattern identifier 1255 may identify an interleaving pattern for the uplink transmission based on the type of the uplink payload, the interleaving pattern including a mapping between one or more virtual resource blocks and one or more physical resource blocks.

The uplink processing module 1260 may process the uplink transmission based on the identified interleaving pattern. In some examples, the uplink processing module 1260 may refrain from processing the second uplink transmission based on the interleaving pattern.

The indication module 1225 may receive, from the UE, the indication of the one or more parameters of the interleaving pattern. In some examples, the indication module 1225 may transmit an indication of the interleaving pattern to the UE, where the indication includes a radio resource control configuration, a medium access control control element indication, a downlink control information indication, or any combination thereof.

The mapping module 1230 may identify the mapping between the one or more virtual resource blocks and the one or more physical resource blocks corresponding to the set of slots. In some examples, the mapping module 1230 may adjust the mapping for the first slot based on a cyclic shift for the first slot of the one or more cyclic shifts, where the interleaving pattern includes the adjusted mapping for the first slot. In some examples, the mapping module 1230 may adjust the mapping for a second slot of the set of slots based on a cyclic shift for the second slot of the one or more cyclic shifts, where the interleaving pattern includes the adjusted mapping for the second slot.

In some examples, the mapping module 1230 may adjust a correspondence for a first virtual resource block bundle from a first portion of the one or more physical resource blocks to a second portion of the one or more physical resource blocks in accordance with the cyclic shift for the first slot, where the cyclic shift for the first slot indicates a quantity of virtual resource block bundles between the first portion of the one or more physical resource blocks and the second portion of the one or more physical resource blocks.

In some examples, the mapping module 1230 may identify a first mapping between one or more virtual resource blocks and one or more physical resource blocks of the interleaving pattern based on the first grouping, where communicating the repetition of the data over the first slot of the one or more slots is based on the first mapping. In some examples, the mapping module 1230 may identify a second mapping between the one or more virtual resource blocks and the one or more physical resource blocks of the interleaving pattern based on the second grouping, where communicating the repetition of the data over a second slot of the one or more slots is based on the second mapping.

The grouping module 1235 may generate a first grouping corresponding to the first slot based on a first interleaving parameter of the at least one different interleaving parameter, the first interleaving parameter corresponding to the first slot. In some examples, the grouping module 1235 may generate a second grouping corresponding to a second slot based on a second interleaving parameter of the at least one different interleaving parameter, the second interleaving parameter corresponding to the second slot.

The type identification module 1245 may identify a type of an uplink payload for the uplink transmission, where identifying the one or more parameters of the interleaving pattern is based on identifying the type of the uplink payload. In some examples, the type identification module 1245 may identify the type of the uplink payload for the uplink transmission.

In some examples, the type identification module 1245 may identify that the type of the uplink payload in one or more symbols of the uplink transmission includes a higher quantity of the one or more physical resource blocks than a second type of the uplink payload in the one or more symbols of the uplink transmission. In some examples, the type identification module 1245 may identify a second type of a second uplink payload for the second uplink transmission. In some cases, the type of the uplink payload includes a hybrid automatic repeat request acknowledgment type, a first channel status information type, a second channel status information type, an uplink shared channel data type, or any combination thereof. In some cases, the second type of the second uplink payload includes an uplink control information type.

The parameter module 1265 may identify an interleaving parameter associated with the type of the uplink payload based on a quantity of code blocks corresponding to the type of the uplink payload. In some examples, the parameter module 1265 may identify the interleaving parameter is based on receiving a pre-configuration of the interleaving pattern, a radio resource control configuration from the base station, or any combination thereof.

FIG. 13 shows a diagram of a system 1300 including a device 1305 that supports interleaving techniques for wireless communications systems in accordance with aspects of the present disclosure. The device 1305 may be an example of or include the components of device 1005, device 1105, or a base station 105 as described herein. The device 1305 may include components for bi-directional voice and data communications including components for transmitting and receiving communications, including a communications manager 1310, a network communications manager 1315, a transceiver 1320, an antenna 1325, memory 1330, a processor 1340, and an inter-station communications manager 1345. These components may be in electronic communication via one or more buses (e.g., bus 1350).

The communications manager 1310 may identify an interleaving pattern including a mapping between one or more virtual resource blocks and one or more physical resource blocks corresponding to a set of slots, the interleaving pattern including one or more parameters at least a first slot corresponding to a repetition of data, perform an interleaving process based on the one or more parameters of the interleaving pattern, the one or more parameters including at least one different interleaving parameter for different slots, one or more cyclic shifts of the interleaving pattern for one or more slots, or both, and communicate, with a UE, the repetition of the one or more slots based on the interleaving process. The communications manager 1310 may also transmit information to a UE scheduling an uplink transmission from the UE to the base station, the uplink transmission corresponding to a type of an uplink payload for the uplink transmission, receive the uplink transmission based on the transmitted information, identify an interleaving pattern for the uplink transmission based on the type of the uplink payload, the interleaving pattern including a mapping between one or more virtual resource blocks and one or more physical resource blocks, and process the uplink transmission based on the identified interleaving pattern.

The communications manager 1310, or its sub-components, may be implemented in hardware, code (e.g., software or firmware) executed by a processor, or any combination thereof. If implemented in code executed by a processor, the functions of the communications manager 1310, or its sub-components may be executed by a general-purpose processor, a DSP, an ASIC, an FPGA or other programmable logic device, discrete gate or transistor logic, discrete hardware components, or any combination thereof designed to perform the functions described in the present disclosure.

The communications manager 1310, or its sub-components, may be physically located at various positions, including being distributed such that portions of functions are implemented at different physical locations by one or more physical components. In some examples, the communications manager 1310, or its sub-components, may be a separate and distinct component in accordance with various aspects of the present disclosure. In some examples, the communications manager 1310, or its sub-components, may be combined with one or more other hardware components, including but not limited to an I/O component, a transceiver, a network server, another computing device, one or more other components described in the present disclosure, or a combination thereof in accordance with various aspects of the present disclosure.

The network communications manager 1315 may manage communications with the core network (e.g., via one or more wired backhaul links). For example, the network communications manager 1315 may manage the transfer of data communications for client devices, such as one or more UEs 115.

The transceiver 1320 may communicate bi-directionally, via one or more antennas, wired, or wireless links as described above. For example, the transceiver 1320 may represent a wireless transceiver and may communicate bi-directionally with another wireless transceiver. The transceiver 1320 may also include a modem to modulate the packets and provide the modulated packets to the antennas for transmission, and to demodulate packets received from the antennas.

In some cases, the wireless device may include a single antenna 1325. However, in some cases the device may have more than one antenna 1325, which may be capable of concurrently transmitting or receiving multiple wireless transmissions.

The memory 1330 may include RAM, ROM, or a combination thereof. The memory 1330 may store computer-readable code 1335 including instructions that, when executed by a processor (e.g., the processor 1340) cause the device to perform various functions described herein. In some cases, the memory 1330 may contain, among other things, a BIOS which may control basic hardware or software operation such as the interaction with peripheral components or devices.

The processor 1340 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In some cases, a memory controller may be integrated into processor 1340. The processor 1340 may be configured to execute computer-readable instructions stored in a memory (e.g., the memory 1330) to cause the device 1305 to perform various functions (e.g., functions or tasks supporting interleaving techniques for wireless communications systems).

The inter-station communications manager 1345 may manage communications with other base station 105, and may include a controller or scheduler for controlling communications with UEs 115 in cooperation with other base stations 105. For example, the inter-station communications manager 1345 may coordinate scheduling for transmissions to UEs 115 for various interference mitigation techniques such as beamforming or joint transmission. In some examples, the inter-station communications manager 1345 may provide an X2 interface within an LTE/LTE-A wireless communication network technology to provide communication between base stations 105.

The code 1335 may include instructions to implement aspects of the present disclosure, including instructions to support wireless communications. The code 1335 may be stored in a non-transitory computer-readable medium such as system memory or other type of memory. In some cases, the code 1335 may not be directly executable by the processor 1340 but may cause a computer (e.g., when compiled and executed) to perform functions described herein.

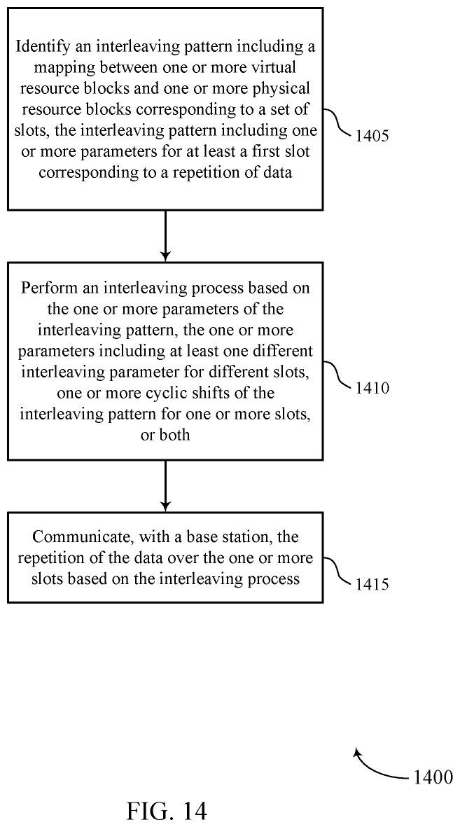

FIG. 14 shows a flowchart illustrating a method 1400 that supports interleaving techniques for wireless communications systems in accordance with aspects of the present disclosure. The operations of method 1400 may be implemented by a UE 115 or its components as described herein. For example, the operations of method 1400 may be performed by a communications manager as described with reference to FIGS. 6 through 9. In some examples, a UE may execute a set of instructions to control the functional elements of the UE to perform the functions described below. Additionally or alternatively, a UE may perform aspects of the functions described below using special-purpose hardware.

At 1405, the UE may identify an interleaving pattern including a mapping between one or more virtual resource blocks and one or more physical resource blocks corresponding to a set of slots, the interleaving pattern including one or more parameters for at least a first slot corresponding to a repetition of data. In some examples, the UE may identify the one or more parameters for the interleaving pattern based at least in part on a pre-configuration of the UE, a configuration received from the base station (e.g., RRC signaling configuring the parameters, a MAC-CE indication of the parameters, DCI indicating the parameters, etc.), or a combination thereof. The operations of 1405 may be performed according to the methods described herein. In some examples, aspects of the operations of 1405 may be performed by an interleaving pattern component as described with reference to FIGS. 6 through 9.

At 1410, the UE may perform an interleaving process based on the one or more parameters of the interleaving pattern, the one or more parameters including at least one different interleaving parameter for different slots, one or more cyclic shifts of the interleaving pattern for one or more slots, or both. In some examples, performing the interleaving process includes interleaving or deinterleaving the one or more virtual resource blocks and the one or more physical resource blocks in accordance with the one or more parameters. For example, the UE may interleave the blocks and perform a cyclic shift on the result of the interleaving process for a slot (e.g., the parameters may include a cyclic shift for a first slot, a cyclic shift for a second slot, etc.). Additionally or alternatively, the UE may perform an interleaving process in accordance with one or more interleaving parameters, such as a quantity of rows of an interleaving matrix, parameters for one or more formulas, among other examples of interleaving parameters as described herein. The operations of 1410 may be performed according to the methods described herein. In some examples, aspects of the operations of 1410 may be performed by an interleaving process component as described with reference to FIGS. 6 through 9.

At 1415, the UE may communicate, with a base station, the repetition of the data over the one or more slots based on the interleaving process. In some examples, the UE may transmit a repetition of data on an uplink channel (e.g., the UE may interleave virtual resource blocks and physical resource blocks associated with the repetition of data and send a transmission on the interleaved resource blocks). Additionally or alternatively, the UE may receive a repetition of data on a downlink channel (e.g., the UE may deinterleave virtual resource blocks and physical resource blocks associated with the repetition of data). The operations of 1415 may be performed according to the methods described herein. In some examples, aspects of the operations of 1415 may be performed by a data component as described with reference to FIGS. 6 through 9.

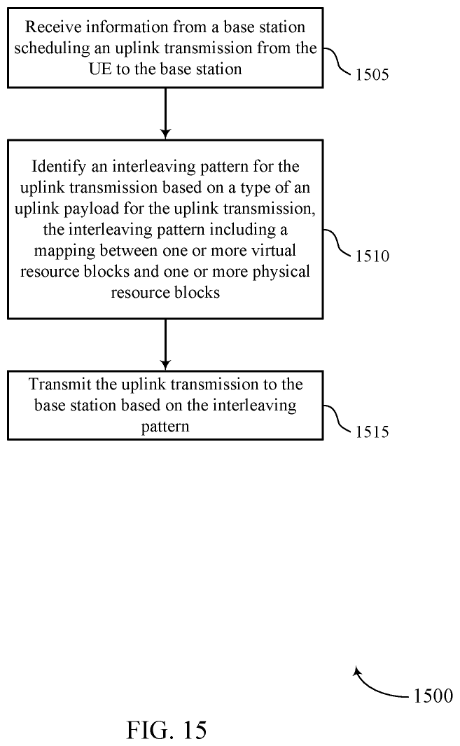

FIG. 15 shows a flowchart illustrating a method 1500 that supports interleaving techniques for wireless communications systems in accordance with aspects of the present disclosure. The operations of method 1500 may be implemented by a UE 115 or its components as described herein. For example, the operations of method 1500 may be performed by a communications manager as described with reference to FIGS. 6 through 9. In some examples, a UE may execute a set of instructions to control the functional elements of the UE to perform the functions described below. Additionally or alternatively, a UE may perform aspects of the functions described below using special-purpose hardware.

At 1505, the UE may receive information from a base station scheduling an uplink transmission from the UE to the base station. For example, the UE may receive semi-persistent scheduling (e.g., via RRC signaling), an uplink grant, among other examples of information scheduling an uplink transmission. The operations of 1505 may be performed according to the methods described herein. In some examples, aspects of the operations of 1505 may be performed by a scheduling information component as described with reference to FIGS. 6 through 9.

At 1510, the UE may identify an interleaving pattern for the uplink transmission based on a type of an uplink payload for the uplink transmission, the interleaving pattern including a mapping between one or more virtual resource blocks and one or more physical resource blocks. In some examples, the UE may identify the interleaving pattern based on an uplink payload type. For example, the UE may identify that a quantity of resource blocks in a symbol of the uplink payload is a first type, and the UE may identify an interleaving pattern associated with the first type (e.g., a HARQ-ACK payload type, a CSI-Part1 payload type, a CSI-Part2 payload type, an UL-SCH type, or any combination thereof). The operations of 1510 may be performed according to the methods described herein. In some examples, aspects of the operations of 1510 may be performed by an interleaving pattern identifier as described with reference to FIGS. 6 through 9.

At 1515, the UE may transmit the uplink transmission to the base station based on the interleaving pattern. For example, the UE may interleave the virtual resource blocks and the physical resource blocks using the identified interleaving pattern and transmit the uplink transmission on the interleaved physical resource blocks. The operations of 1515 may be performed according to the methods described herein. In some examples, aspects of the operations of 1515 may be performed by an uplink transmitter as described with reference to FIGS. 6 through 9.

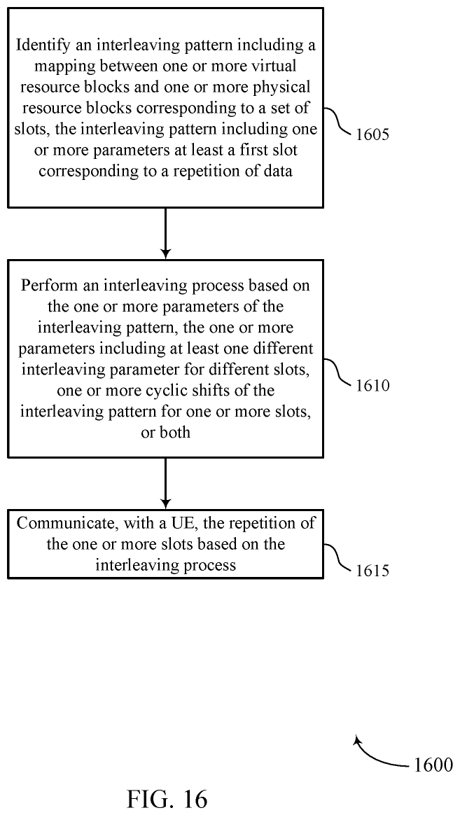

FIG. 16 shows a flowchart illustrating a method 1600 that supports interleaving techniques for wireless communications systems in accordance with aspects of the present disclosure. The operations of method 1600 may be implemented by a base station 105 or its components as described herein. For example, the operations of method 1600 may be performed by a communications manager as described with reference to FIGS. 10 through 13. In some examples, a base station may execute a set of instructions to control the functional elements of the base station to perform the functions described below. Additionally or alternatively, a base station may perform aspects of the functions described below using special-purpose hardware.

At 1605, the base station may identify an interleaving pattern including a mapping between one or more virtual resource blocks and one or more physical resource blocks corresponding to a set of slots, the interleaving pattern including one or more parameters at least a first slot corresponding to a repetition of data. In some examples, the base station may identify the one or more parameters for the interleaving pattern based at least in part on a pre-configuration of the base station, an indication of the parameters received from the UE, or a combination thereof. The operations of 1605 may be performed according to the methods described herein. In some examples, aspects of the operations of 1605 may be performed by an interleaving pattern module as described with reference to FIGS. 10 through 13.

At 1610, the base station may perform an interleaving process based on the one or more parameters of the interleaving pattern, the one or more parameters including at least one different interleaving parameter for different slots, one or more cyclic shifts of the interleaving pattern for one or more slots, or both. In some examples, performing the interleaving process includes interleaving or deinterleaving the one or more virtual resource blocks and the one or more physical resource blocks in accordance with the one or more parameters. For example, the base station may interleave the blocks and perform a cyclic shift on the result of the interleaving process for a slot (e.g., the parameters may include a cyclic shift for a first slot, a cyclic shift for a second slot, etc.). Additionally or alternatively, the base station may perform an interleaving process in accordance with one or more interleaving parameters, such as a quantity of rows of an interleaving matrix, parameters for one or more formulas, among other examples of interleaving parameters as described herein. The operations of 1610 may be performed according to the methods described herein. In some examples, aspects of the operations of 1610 may be performed by an interleaving process module as described with reference to FIGS. 10 through 13.

At 1615, the base station may communicate, with a UE, the repetition of the one or more slots based on the interleaving process. In some examples, the base station may transmit a repetition of data on an uplink channel (e.g., the base station may interleave virtual resource blocks and physical resource blocks associated with the repetition of data and send a transmission on the interleaved resource blocks). Additionally or alternatively, the base station may receive a repetition of data on a downlink channel (e.g., the base station may deinterleave virtual resource blocks and physical resource blocks associated with the repetition of data). The operations of 1615 may be performed according to the methods described herein. In some examples, aspects of the operations of 1615 may be performed by a data module as described with reference to FIGS. 10 through 13.

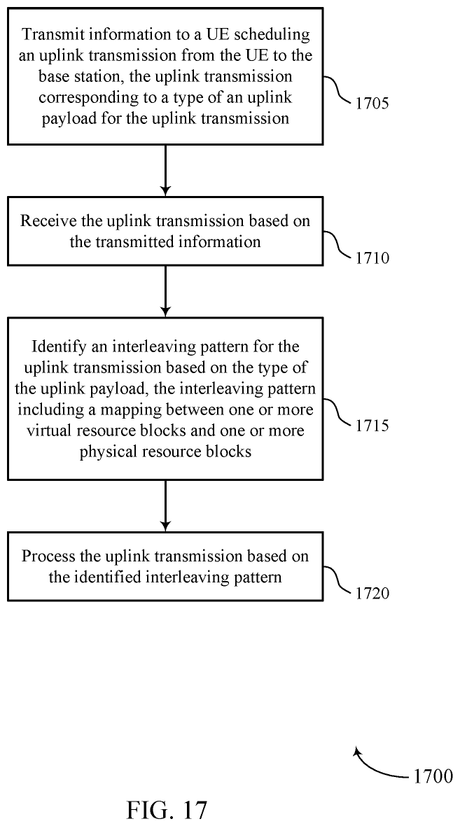

FIG. 17 shows a flowchart illustrating a method 1700 that supports interleaving techniques for wireless communications systems in accordance with aspects of the present disclosure. The operations of method 1700 may be implemented by a base station 105 or its components as described herein. For example, the operations of method 1700 may be performed by a communications manager as described with reference to FIGS. 10 through 13. In some examples, a base station may execute a set of instructions to control the functional elements of the base station to perform the functions described below. Additionally or alternatively, a base station may perform aspects of the functions described below using special-purpose hardware.

At 1705, the base station may transmit information to a UE scheduling an uplink transmission from the UE to the base station, the uplink transmission corresponding to a type of an uplink payload for the uplink transmission. For example, the base station may transmit semi-persistent scheduling (e.g., via RRC signaling), an uplink grant, among other examples of information scheduling an uplink transmission. The operations of 1705 may be performed according to the methods described herein. In some examples, aspects of the operations of 1705 may be performed by a scheduling information module as described with reference to FIGS. 10 through 13.

At 1710, the base station may receive the uplink transmission based on the transmitted information. For example, the base station may receive the uplink transmission on resource indicated by a semi-persistent scheduling configuration, an uplink grant, or both. The operations of 1710 may be performed according to the methods described herein. In some examples, aspects of the operations of 1710 may be performed by an uplink receiver as described with reference to FIGS. 10 through 13.

At 1715, the base station may identify an interleaving pattern for the uplink transmission based on the type of the uplink payload, the interleaving pattern including a mapping between one or more virtual resource blocks and one or more physical resource blocks. In some examples, the base station may identify the interleaving pattern based on an uplink payload type. For example, the base station may identify that a quantity of resource blocks in a symbol of the uplink payload is a first type, and the UE may identify an interleaving pattern associated with the first type (e.g., a HARQ-ACK payload type, a CSI-Part1 payload type, a CSI-Part2 payload type, an UL-SCH type, or any combination thereof). The operations of 1715 may be performed according to the methods described herein. In some examples, aspects of the operations of 1715 may be performed by a pattern identifier as described with reference to FIGS. 10 through 13.

At 1720, the base station may process the uplink transmission based on the identified interleaving pattern. For example, the base station may deinterleave the virtual resource blocks and the physical resource blocks using the identified interleaving pattern and decode the uplink transmission accordingly. The operations of 1720 may be performed according to the methods described herein. In some examples, aspects of the operations of 1720 may be performed by an uplink processing module as described with reference to FIGS. 10 through 13.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

1. A method for wireless communications at a user equipment (UE), comprising:
identifying an interleaving pattern comprising a mapping between one or more virtual resource blocks and one or more physical resource blocks corresponding to a set of slots, the interleaving pattern comprising one or more parameters for at least a first slot corresponding to a repetition of data;
performing an interleaving process based at least in part on the one or more parameters of the interleaving pattern, the one or more parameters comprising at least one different interleaving parameter for different slots, one or more cyclic shifts of the interleaving pattern for one or more slots, or both; and
communicating, with a base station, the repetition of the data over the one or more slots based at least in part on the interleaving process.

2. The method of claim 1, further comprising:
identifying the one or more parameters of the interleaving pattern based at least in part on a pre-configuration associated with the interleaving pattern, a configuration received from a base station, or a combination thereof.

3. The method of claim 2, further comprising:
receiving an indication from the base station, wherein identifying the one or more parameters is based at least in part on the indication, and wherein the indication comprises a radio resource control configuration, a medium access control control element indication, a downlink control information indication, or any combination thereof.

4. The method of claim 2, further comprising:
receiving a communication from the base station; and
identifying the pre-configuration associated with the interleaving pattern based at least in part on the received communication, wherein identifying the one or more parameters is based at least in part on the pre-configuration.

5. The method of claim 2, wherein identifying the one or more parameters of the interleaving pattern comprises:
identifying the one or more parameters of the interleaving pattern for at least the first slot based at least in part on a slot index of the first slot, a total number of slots corresponding to the repetition of the data, or both.

6. The method of claim 1, further comprising:
identifying the mapping between the one or more virtual resource blocks and the one or more physical resource blocks corresponding to the set of slots; and
adjusting the mapping for the first slot based at least in part on a cyclic shift for the first slot of the one or more cyclic shifts, wherein the interleaving pattern comprises the adjusted mapping for the first slot.

7. The method of claim 6, further comprising:
adjusting the mapping for a second slot of the set of slots based at least in part on a cyclic shift for the second slot of the one or more cyclic shifts, wherein the interleaving pattern comprises the adjusted mapping for the second slot.

8. The method of claim 6, wherein adjusting the mapping for the first slot based at least in part on the cyclic shift for the first slot comprises:
adjusting a correspondence for a first virtual resource block bundle from a first portion of the one or more physical resource blocks to a second portion of the one or more physical resource blocks in accordance with the cyclic shift for the first slot, wherein the cyclic shift for the first slot indicates a quantity of virtual resource block bundles between the first portion of the one or more physical resource blocks and the second portion of the one or more physical resource blocks.

9. The method of claim 1, further comprising:
generating a first grouping corresponding to the first slot based at least in part on a first interleaving parameter of the at least one different interleaving parameter, the first interleaving parameter corresponding to the first slot; and
identifying a first mapping between one or more virtual resource blocks and one or more physical resource blocks of the interleaving pattern based at least in part on the first grouping, wherein communicating the repetition of the data over the first slot of the one or more slots is based at least in part on the first mapping.

10. The method of claim 9, further comprising:
generating a second grouping corresponding to a second slot based at least in part on a second interleaving parameter of the at least one different interleaving parameter, the second interleaving parameter corresponding to the second slot; and
identifying a second mapping between the one or more virtual resource blocks and the one or more physical resource blocks of the interleaving pattern based at least in part on the second grouping, wherein communicating the repetition of the data over a second slot of the one or more slots is based at least in part on the second mapping.

11. The method of claim 1, wherein communicating the repetition of the data over at least the first slot based at least in part on the one or more parameters of the interleaving pattern comprises:
transmitting the repetition of the data over an uplink shared channel.

12. The method of claim 11, wherein performing the interleaving process comprises:
interleaving the one or more virtual resource blocks and the one or more physical resource blocks in accordance with the one or more parameters, wherein transmitting the repetition of the data is based at least in part on the interleaving.

13. The method of claim 1, wherein communicating the repetition of the data over at least the first slot based at least in part on the one or more parameters of the interleaving pattern comprises:
receiving the repetition of the data over a downlink shared channel.

14. The method of claim 13, wherein performing the interleaving process comprises:
deinterleaving the one or more virtual resource blocks and the one or more physical resource blocks in accordance with the one or more parameters based at least in part on receiving the repetition of the data.

15. The method of claim 1, further comprising:
receiving information from the base station scheduling an uplink transmission from the UE to the base station; and
identifying a type of an uplink payload for the uplink transmission, wherein identifying the one or more parameters of the interleaving pattern is based at least in part on identifying the type of the uplink payload.

16. The method of claim 15, wherein communicating the repetition of the data comprises:
transmitting the uplink transmission based at least in part on the interleaving pattern based at least in part on the identified type of the uplink payload.

17. The method of claim 15, further comprising:
refraining from processing the uplink transmission based at least in part on the interleaving pattern based at least in part on the identified type of the uplink payload, wherein communicating the repetition of the data is based at least in part on refraining from processing the uplink transmission.

18. A method for wireless communications at a user equipment (UE), comprising:
receiving information from a base station scheduling an uplink transmission from the UE to the base station;
identifying an interleaving pattern for the uplink transmission based at least in part on a type of an uplink payload for the uplink transmission, the interleaving pattern comprising a mapping between one or more virtual resource blocks and one or more physical resource blocks; and
transmitting the uplink transmission to the base station based at least in part on the interleaving pattern.

19. The method of claim 18, further comprising:
identifying the type of the uplink payload for the uplink transmission based at least in part on the information from the base station.

20. The method of claim 19, wherein identifying the type of the uplink payload for the uplink transmission comprises:
identifying that the type of the uplink payload in one or more symbols of the uplink transmission comprises a higher quantity of the one or more physical resource blocks than a second type of the uplink payload in the one or more symbols of the uplink transmission.

21. The method of claim 18, further comprising:
identifying an interleaving parameter associated with the type of the uplink payload based at least in part on a quantity of code blocks corresponding to the type of the uplink payload.

22. The method of claim 21, wherein:
identifying the interleaving parameter is based at least in part on receiving a pre-configuration of the interleaving pattern, a radio resource control configuration from the base station, or any combination thereof.

23. The method of claim 18, wherein the type of the uplink payload comprises a hybrid automatic repeat request acknowledgment type, a first channel status information type, a second channel status information type, an uplink shared channel data type, or any combination thereof.

24. The method of claim 18, further comprising:
receiving second information from the base station scheduling a second uplink transmission from the UE to the base station;
identifying a second type of a second uplink payload for the second uplink transmission; and
refraining from processing the second uplink transmission based at least in part on the interleaving pattern.

25. The method of claim 24, wherein the second type of the second uplink payload comprises an uplink control information type.

26. The method of claim 18, wherein identifying the interleaving pattern for the uplink transmission comprises:
identifying one or more parameters of the interleaving pattern for at least a first slot corresponding to a repetition of data based at least in part on a pre-configuration, an indication from the base station, or both, wherein the one or more parameters comprise at least one different interleaving parameter for different slots, one or more cyclic shifts of the interleaving pattern for one or more slots, or both.

27. A method for wireless communications at a base station, comprising:
identifying an interleaving pattern comprising a mapping between one or more virtual resource blocks and one or more physical resource blocks corresponding to a set of slots, the interleaving pattern comprising one or more parameters at least a first slot corresponding to a repetition of data;
performing an interleaving process based at least in part on the one or more parameters of the interleaving pattern, the one or more parameters comprising at least one different interleaving parameter for different slots, one or more cyclic shifts of the interleaving pattern for one or more slots, or both; and
communicating, with a user equipment (UE), the repetition of the one or more slots based at least in part on the interleaving process.

28. The method of claim 27, further comprising:
identifying the one or more parameters of the interleaving pattern based at least in part on a pre-configuration associated with the interleaving pattern, an indication of the one or more parameters of the interleaving pattern, or a combination thereof.

29. (canceled)

30. (canceled)

31. The method of claim 27, further comprising:
identifying the mapping between the one or more virtual resource blocks and the one or more physical resource blocks corresponding to the set of slots; and
adjusting the mapping for the first slot based at least in part on a cyclic shift for the first slot of the one or more cyclic shifts, wherein the interleaving pattern comprises the adjusted mapping for the first slot.

32. (canceled)

33. (canceled)

34. The method of claim 27, further comprising:
generating a first grouping corresponding to the first slot based at least in part on a first interleaving parameter of the at least one different interleaving parameter, the first interleaving parameter corresponding to the first slot; and
identifying a first mapping between one or more virtual resource blocks and one or more physical resource blocks of the interleaving pattern based at least in part on the first grouping, wherein communicating the repetition of the data over the first slot of the one or more slots is based at least in part on the first mapping.

35-43. (canceled)

44. A method for wireless communications at a base station, comprising:
transmitting information to a user equipment (UE) scheduling an uplink transmission from the UE to the base station, the uplink transmission corresponding to a type of an uplink payload for the uplink transmission;
receiving the uplink transmission based at least in part on the transmitted information;
identifying an interleaving pattern for the uplink transmission based at least in part on the type of the uplink payload, the interleaving pattern comprising a mapping between one or more virtual resource blocks and one or more physical resource blocks; and
processing the uplink transmission based at least in part on the identified interleaving pattern.

45. The method of claim 44, further comprising:
identifying the type of the uplink payload for the uplink transmission.

46. (canceled)

47. The method of claim 44, further comprising:
identifying an interleaving parameter associated with the type of the uplink payload based at least in part on a quantity of code blocks corresponding to the type of the uplink payload.

48. (canceled)

49. The method of claim 44, wherein the type of the uplink payload comprises a hybrid automatic repeat request acknowledgment type, a first channel status information type, a second channel status information type, an uplink shared channel data type, or any combination thereof.

50-52. (canceled)

53. An apparatus for wireless communications at a user equipment (UE), comprising:
a processor,
memory coupled with the processor; and
instructions stored in the memory and executable by the processor to cause the apparatus to:
identify an interleaving pattern comprising a mapping between one or more virtual resource blocks and one or more physical resource blocks corresponding to a set of slots, the interleaving pattern comprising one or more parameters for at least a first slot corresponding to a repetition of data;
perform an interleaving process based at least in part on the one or more parameters of the interleaving pattern, the one or more parameters comprising at least one different interleaving parameter for different slots, one or more cyclic shifts of the interleaving pattern for one or more slots, or both; and
communicate, with a base station, the repetition of the data over the one or more slots based at least in part on the interleaving process.

54-64. (canceled)
